(19) United States
(12) Patent Application Publication
(10) Pub. No.: US 2014/0059518 A1
(43) Pub. Date: Feb. 27, 2014

(54) Method for Object Oriented Programming of Programmable Logic Controllers in Graphical Programming Languages

(71) Applicants: Dennis Allen Sierk, Huntsville, AL (US); Dustin Donavon Sierk, Huntsville, AL (US)

(72) Inventors: Dennis Allen Sierk, Huntsville, AL (US); Dustin Donavon Sierk, Huntsville, AL (US)

(73) Assignee: VELOCIO NETWORKS, INC., Huntsville, AL (US)

(21) Appl. No.: 13/593,599

(22) Filed: Aug. 24, 2012

(51) Int. Cl. G06F 9/44

(52) U.S. Cl. 717/107; 717/127

(57) ABSTRACT

A method for implementing object oriented programming in Programmable Logic Controller graphical programming languages. The method for creating, executing and controlling objects and object subroutines, including allocation of private data memory, passing of parameters and parameter references and passing of program control. The extension of object programming to embedded objects resident on a separate processor coupled with the passing of data and control between the embedded object and its host processor. The further implementation of embedded object automatic identification capability to enable the implementation of “plug and play” functionality within PLC systems.

### BACKGROUND

### Prior Art

The following is a tabulation of some prior art that presently appears relevant

U.S. Patents

| | Kind | | |
|---|---|---|---|
| Pat. No. | Code | Issue Date | Patentee |
| U.S. Pat. No. 5,546,519 | A | Aug. 13, 1996 | Berry et al. |
| U.S. Pat. No. 5,787,413 | A | Jul. 28, 1998 | Kauffman et al. |
| U.S. Pat. No. 5,812,394 | A | Sep. 22, 1998 | Lewis et al. |
| U.S. Pat. No. 5,907,707 | A | May 25, 1999 | Ramalingam et al. |
| U.S. Pat. No. 6,366,300 | B1 | Apr. 02, 2002 | Ohara et al. |
| U.S. Pat. No. 6,421,821 | B1 | Jul. 16, 2002 | Lavalle et al. |
| US2003/0070159 | A1 | Apr. 10, 2003 | Webb |
| US2012/0117537 | A1 | May 10, 2012 (pub | Sierk et al. |
| | | date) | |

### Background

This invention relates to a method for implementing object oriented programming within graphical programming languages utilized in Programmable Logic Controllers and similar devices. In particular, it relates to a method for providing an application programmer the ability to define and program software objects that exhibit a desired behavior associated with a specified set of data, to be used as modular components of an application program. This invention further relates to a method for distributing software objects between multiple processors within a PLC or similar device.

Object oriented programming is not a new concept. The core concept of a linked association of data related to an entity and the behavior or functionality of that entity being tightly coupled as an object seems to have first appeared at MIT in the late 1950s. Some of the earliest applications of object oriented programming concepts related to artificial intelligence. Some of the early programming languages, dating back to the 1960s, which incorporated object oriented programming concepts include ALGOL, Lisp and Smalltalk. The term, object oriented programming, appeared with the introduction of Smalltalk in the 1970s. Microsoft's C++ programming language brought object oriented programming to the mainstream in the early 1990s. Object oriented programming remains predominate in text based high level languages including C++, C Sharp, Java and .Net programming.

An object, in object oriented programming, is a set of data pertaining to the object and a functional program or programs that operate on the set of data to accomplish some goal. There can be many instances of the same object type. Each instance of the object owns unique local data that is not available to any other program or object, unless specifically allowed by the object. Data can be passed into and out of the object through a defined interface, so other programs or objects can communicate with the object and use the object.

For an understanding of objects as related to a control application, consider a cruise ship. This cruise ship has two engine systems, driving propellers on the right and left (or starboard and port) sides of the ship. The control of each engine involves a throttle, a transmission, monitoring of temperature and other safety sensors. Each engine system could be controlled by an instance of an engine control object. The data for each engine would be individually related to that engine. The two engines could be in different states, but they would have the same functionality and interface with the greater program. For instance, if the captain wanted to turn starboard, the high level control program might pass data and commands to the port engine object to throttle to full speed forward and pass data and commands to the starboard engine object to operate at twenty percent forward throttle.

One of the most fundamental device classes within industrial automation is the Programmable Logic Controller, or PLC. A device that constitutes an enhanced capability PLC is called a Programmable Automation Controller, or PAC. A similar device that is designed to easily be incorporated into networks of like and compatible devices is called a Programmable Network Controller, or PNC. There are other, similar devices on the market, as well. Within this document, the term PLC is used generically to refer to any of these devices or any device or system which is programmed in a PLC type graphical programming language for the purpose of monitoring, controlling, or testing.

PLCs date back to the late 1960s. They were originally developed as a solid state devices used in simple control systems to take the place of controllers built from interconnected electromechanical relays. The primary programming language began as simply a graphic symbol language that used combinations of symbolic relay contacts and relay coils, in what are called rungs to form logic statements. An example of basic ladder logic is shown in FIG. 1a. When contacts, 102, are placed in the proper series and parallel patterns, any type of boolean expression can be formed. Ladder logic programs simply execute one rung after another until the complete sequence of rungs is executed, then they process IO and start all over. Ladder logic rungs originally solved to turn a digital bit, referred to as a coil, 104, on or off. A coil could be a digital output control or an internal logic state. Through the years, mathematical capabilities, timing functions, 106, and other higher order function blocks, 108, have been added to ladder logic. A few manufacturers have even added subroutine capability.

Other graphical programming languages have also been applied to PLCs. One of the most important of those languages is Flow Chart Programming. Flow chart programming is a little more free form type of programming consisting of a combination of processing blocks and decision blocks. A flow chart program snippet is shown in FIG. 1b. A flow chart program consists of a sequence of processing blocks, 110, and decision blocks, 112, connected, 114, in the proper sequence to create a logic flow that defines the program operation.

While object oriented programming is common to the standard textual languages used in computers, it has not been implemented in the graphical languages used to program PLCs.

### Applicability of Object Oriented Programming to PLCs

The primary use for PLCs is the monitoring and control of devices, systems, machines or buildings. They measure inputs, make calculations, perform other processing functions, communicate and control outputs. The total range of potential applications is enormous. PLCs are found in manufacturing lines, individual machines of all types, theme parks, car washes, prisons, homes, vehicles and any other application that requires intelligent automated control.

In a great many applications, subsections of the overall system can be viewed as objects. A programming object is a set of data directly related to the object, coupled with a functional program or programs that operate on its data to give the object functionality. If a cereal manufacturing plant has 10 different cereal box fill lines, they can be viewed as 10 program objects of the same type. Each line has box location sensors, scales, fill chute controls, conveyor motor controls, and other sensors and actuators. The required operation of each line is the control necessary to move cereal boxes down the line, fill each box to the required weight, count the production, seal each box and place it in a shipping crate. The ability to program one function program, then reuse it ten times with a different set of program operational data would lead to more efficient, consistent and maintainable program development. Each line could be in a different operational state, but would operate according to the same function logic, with data that pertains uniquely to the line.

In most significant PLC applications, identifiable control objects are present. As an illustration, consider the following examples.
In an office building, each floor could be viewed as an instance of a floor object, with the same type of control over heat, ventilation, security, and smoke detection.
A multi bay car wash could be viewed as multiple instances of a car bay object.
In a gas distribution system with a trunk line and multiple distribution branches, each distribution branch could be implemented as a unique instance of the distribution branch object.

There are many other examples of multiple identical, or very similar instances within the same system. Any such system is a prime candidate for object oriented programming.

Another situation where object oriented programming can lead to significant benefits is any time the same control operation is applied to different applications. It is very common for system integrators to specialize in one, or a few industries or industry applications. The system integrator will frequently face identical requirements of various aspects of different applications. If he were able to build standard application objects that he could link into each new application, he would greatly improve his efficiency and eliminate a great many potential errors. Reuse of standard objects from system to system would provide great benefit.

Some of the benefits that can be provided by the incorporation of object oriented programming capability to graphical programming applications include the following.
1) Portability of standard logic algorithm modules
2) Breaking large programs into more easily understood program segments
3) Protection against unintended consequences of program change, through the ability to isolate code sections and protect variable data
4) Reduced program development time
5) Easier validation of program operation
6) Easier, less expensive program maintenance
7) Improved program quality

Further benefits can be realized by expanding object oriented programming capability to provide for the distribution of program objects to multiple processors within a PLC. Technology currently exists to utilize multiple processors within a PLC. It is common to have a microcontroller in each IO module. It is also possible and not uncommon to have more than one microcontroller on some PLC modules. PLC IO and function modules can also be placed at physically different locations, within the application system and may be powered by different power sources.

Provision of the capability to distribute program object to multiple processors within a PLC system would provide benefits which include the following.
1) The ability to place objects at the point of application to improve responsiveness.
2) Improved system process throughput through the division of work.
3) The ability to operate object operations in either a synchronized or an asynchronous manner.
4) The capability to continue operation in a section of the application in the event of loss of power or other stoppage event in another section of the application.
5) The capability to productize predefined object programs, together with associated machinery for use in a larger system, allowing “plug and play” capability to complex applications.

### SUMMARY OF THE INVENTION

The purpose of this invention is the creation of a method which provides the user the ability to design, program, monitor and debug program objects for use in PLC graphical program applications. The invention includes the following features.
1) Fully independent graphical programs, created in Ladder Logic, Flow Charts or other graphical programming language, that act as subroutine objects and can be called by other graphical language programs.
2) The capability to create multiple instances of subroutine object data, which defines an instance of the object.
3) The capability to assign local variables.
4) The capability for local variable data to remain static. In other words, the value or state of the variable remains constant between subroutine calls.
5) The capability to pass parameters by value to the graphical program object instance.
6) The capability to pass parameters by reference to the graphical program object instance.
7) The capability for an instance of the graphical object to call other graphical object instances.
8) The capability for a subroutine object to provide or deny access to its instance data to object subroutines it calls.
9) The capability to distribute objects to multiple processors within a PLC.
10) The capability to debug inside each instance of a subroutine object.
11) The capability for the development system to view data from within each instance of a subroutine object.

### DRAWINGS BRIEF DESCRIPTION

FIG. 1a shows an example of ladder logic programming

FIG. 1b shows an example of flow chart programming

FIG. 2 shows a development and debug system during the initial creation of an object subroutine

FIG. 3a shows the initial screen for a newly created ladder logic subroutine

FIG. 3b show the development and debug system during the process of defining object subroutine data transfers.

FIG. 3c shows program entry of an object subroutine call

FIG. 4a shows an example cookie batter mix line

FIG. 4b shows a list of data that must be defined for an object controlling the mix line shown in FIG. 4a

FIG. 5a shows an initialization object function implemented in flow chart programming

FIG. 5b shows the start of an initialization object function implemented in ladder logic programming

FIG. 5c shows the remainder of the initialization object function started in FIG. 5b

FIG. 6a shows an example object control function implemented in flow chart programming

FIG. 6b is a continuation of FIG. 6a

FIG. 6c shows an example object control function implemented in ladder logic programming

FIG. 6d is a continuation of FIG. 6c

FIG. 7a shows an example high level program which calls the object programs illustrated in FIGS. 5 & 6 implemented in flow chart programming

FIG. 7b is a continuation of FIG. 7a

FIG. 7c is a further continuation of FIG. 7a

FIG. 7d shows an example high level program which calls the object programs illustrated in FIGS. 5 & 6 implemented in ladder logic programming

FIG. 7e is a continuation of FIG. 7d

FIG. 7f is a further continuation of FIG. 7d

FIG. 8 shows object memory allocation in the preferred embodiment

FIG. 9a shows the data definition associated with the entry of an embedded object

FIG. 9b shows a typical embedded object call from a host program

FIG. 9c shows a typical embedded object program segment

FIG. 10a shows the high level program flow of a PLC implementing object programming

FIG. 10b shows the communications logic flow in a PLC implementing object programming

FIG. 10c show relevant logic of the Decode program

FIG. 11a shows core logic for the execution and debug control of application programs

FIG. 11b shows program logic used to decode and execute an application program rung or block

FIG. 11c shows program logic for object subroutine call and return

FIG. 11d shows the logic involved in the execution of an embedded object call block

FIG. 12a shows the high level program flow of an embedded object controller

FIG. 12b shows the communications logic flow in an embedded object controller

FIG. 12c show relevant logic of the embedded object controller Decode program

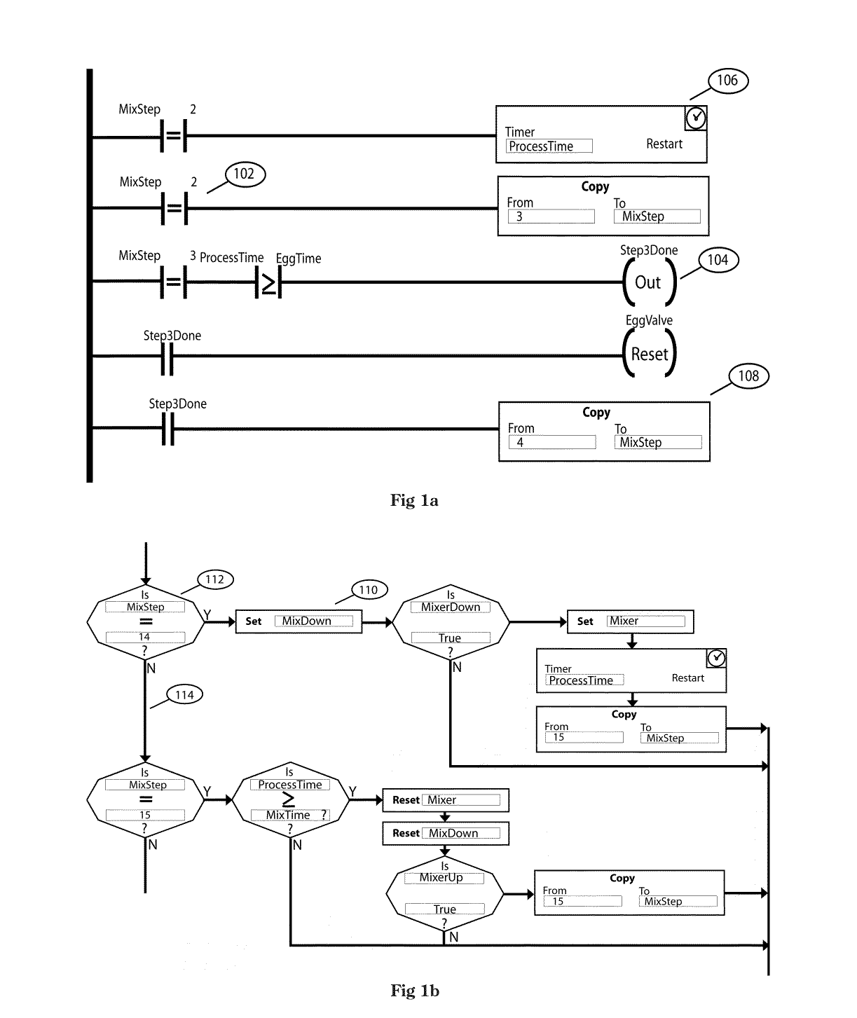

### DETAILED DESCRIPTION

### Conceptual Overview

The concept for a method to create, debug and use software objects in graphical programming languages, including Ladder Logic and Flow Charts is outlined in the following text.

The graphical language object programming solution:
provides for the creation of subroutines within a graphical programming environment.
provides the capability for the application developer to define a set of static data variables associated with a subroutine or subroutines, constituting object data, which compose a subroutine object and are unique to each instance of the subroutine object.
provides the capability for the application developer to define the data interface, including pass by value and pass by reference to be used by the subroutine.
provides the capability for object data to be protected and available only to the instance of the object, or be made available by the subroutine to subroutine objects called or used by the subroutine object.
provides the capability for subroutine objects to call other subroutine objects.
provides the capability for the application developer to define which instance of object data is to be used by the subroutine for each call to the subroutine.
provides the capability for subroutine objects to be separate from the application program and be reused in many applications.
provides for the capability to distribute objects to multiple processors within a controller.
provides for data to be passed between a distributed object and its calling program in an asynchronous manner.

A software object includes a block of data that is unique to the object and a set of behavior associated with it. The behavior is defined by one or more subroutines that are associated with the object data. In this case, the subroutines are written in graphical fashion, using ladder logic or flow charts.

### DETAILED DESCRIPTION OF THE PREFERRED EMBODIMENT

The embodiment of a system for implementing object oriented programmability consists of two primary components. The first component is the Development and Debug System. The second is the execution platform. The execution platform is the PLC and any embedded object controllers associated with the PLC. Both of these entities consist of electronic CPU based hardware and associated software.

The Development and Debug System is a computer, with a CPU, memory, storage, operator input devices, a graphical display system, a means to communicate with the execution platform and software that implements the logic described in the following text.

The execution platform is an entity, controlled by a CPU, which includes memory, a mechanism for storing programs and operational data, a means of monitoring and controlling real world inputs and outputs, and a means of communications with the Development and Debug System and software or firmware that implements the logic described on the following pages. The Execution Platform may exist as an electronic device called a PLC, PAC, PNC, embedded object controller or anything else.

The embodiment of the invention incorporates the interactive functionality of the development and target systems and the eventual stand alone execution by the execution engine. The description of the embodiment will detail a system which allows all levels of programming to be performed in either ladder logic or flow charts.

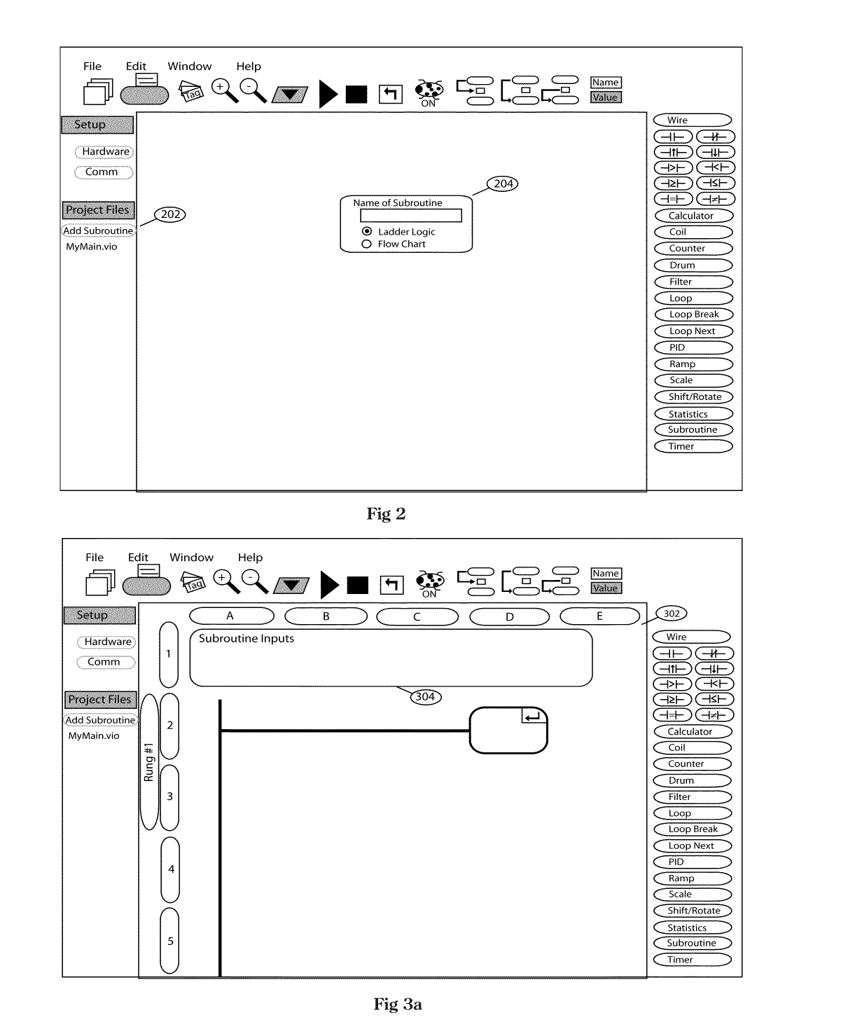

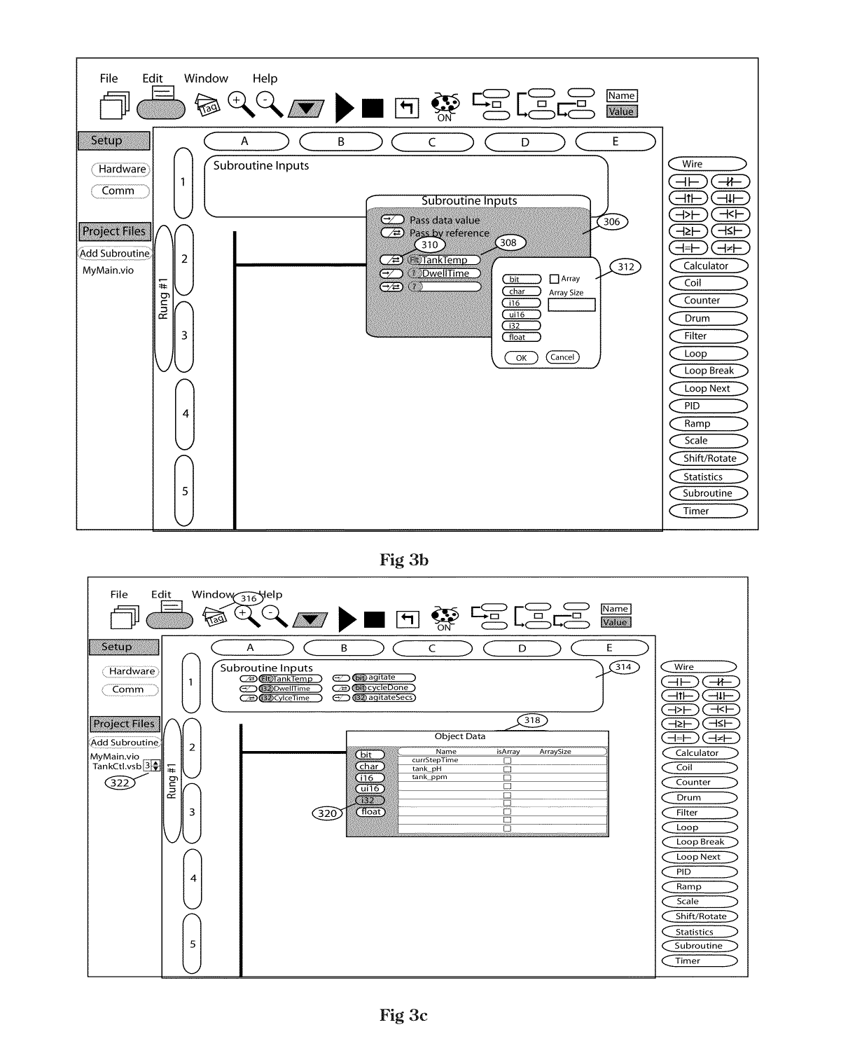

The creation of subroutine objects starts on the Development and Debug System on a screen similar to that shown in FIG. 2. If the application programmer clicks item 202, he begins the process of creating a subroutine. The Development system next asks the programmer to select a name for the subroutine and whether it is a ladder logic or flow chart routine, item 204. The programmer enters a name. Once the name is entered a separate subroutine programming window pops up, shown in FIG. 3a, item 302.

At the top of the subroutine window, item 304 of FIG. 3a, is an area for defining the data which is passed in and out of the subroutine. In addition to data passed in and out, any global variable can be accessed. A programmer who wishes to create an object subroutine that can be easily used in multiple systems would avoid the use of global variables within the subroutine.

Clicking the area, item 304, of the window labeled Subroutine Inputs, causes a parameter definition window, FIG. 3b, item 306, to pop up. In this window, the application programmer can enter any number of parameters that can be passed in to the subroutine by value, or by reference. Pass type is indicated by the symbol identified as item 310. Pass by value data is the data shown in conjunction with the single arrow indicating that a numeric value is passed into the subroutine. Pass by reference data is shown with two arrows, pointing in opposite directions, indicating that data can be passed both in and out. Pass by reference data is not actually a number. It is a pointer to where the data is located. Since it is a pointer, the pointer can be used to either retrieve the data or to write data. Pass by reference is the mechanism used to pass data out of an object. The parameter definition window allows the application programmer to select whether each item is passed by value or by reference. The tag names, item 308, defined are the names used in the subroutine. The data or reference may be called something else by the program or subroutine that calls this subroutine. A further definition of each tag data type is shown in fly out window, item 312. FIG. 3c, item 314, shows the complete list of passed data, once it has been defined.

The embodiment of defining local object data is done in the same manner as defining global data. If the application programmer selects the Tag definition item, FIG. 3c item 316, the tag name definition screen, item 318, will pop up. This screen will allow local object data to be defined. The screen shows that the application programmer can select each data type and define any number of data items of that type required by the object. The drawing shows, item 320, that the programmer has currently selected to define 32 bit integer parameters.

Once the object data is defined, the embodiment allows the application programmer to define the number of objects used in the system. Item 322 illustrates the use of a software tool to set the number of instances of the object through increase and decrease buttons, with the minimum number of objects defined as one. When the program compiles, it will set aside the selected number of local data objects for each subroutine object.

Once the definitions of the data interface and local object data are made, the logic necessary to define the subroutine operation can be entered. At any time in the development process, the data interface and local object data can be edited to add or delete subroutine input data or object data.

### Example Object Oriented Programming Application

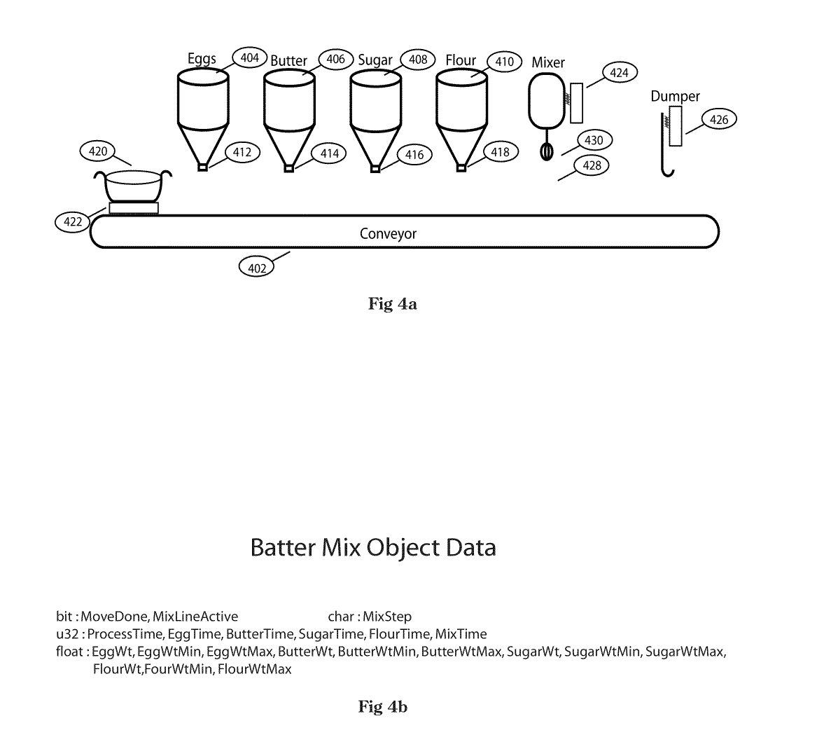

Consider a cookie factory with three batter mix lines, controlled by the same PLC. Each mix line is configured as shown in FIG. 4a. Each mix line has a conveyor, with a conveyor motor, item 402. Each line has four ingredient hoppers 404, 406, 408 and 410. Each hopper has a release valve 412, 414, 416, and 418. Attached to each conveyor is a mix bowl 420. Each mix bowl is mounted on a scale, 422. At the end of the line is a mixer, 424 and a dumper, 426. The mixer has an inserter that can be controlled to the insert, 428 or extract, 430 positions.

In a PLC control application program, the three mix lines could be implemented as three objects of the same type. The ingredient dispensing, mixing and dumping are simple operations. The conveyor movement to defined locations is a little more complex. That could be implemented as a separate object type, with one instance of the conveyor object associated with each mix line. The description of the implementation will detail the mix line and will illustrate the use of the conveyor object by the mix line object.

The definition of the mix line object proceeds as previously defined. This object will have an initialization subroutine and an operating subroutine. Unique local object data is available to each subroutine. For the batter mix, the data listed in FIG. 4b must be defined as previously discussed with regard to FIG. 3c. This data will constitute the object data. A unique set of this object data will be associated with each instance of the mix line object.

The two object subroutines, InitMix and BatterMix each have a different set of subroutine input data, which is defined as previously described in association with FIG. 3b. This is a characteristic of object subroutines. Object subroutines share a common set of object data, but each subroutine can have a different data interface to the routine which calls, or uses it. The input data for each subroutine is shown at the top of each subroutine in figures that follow.

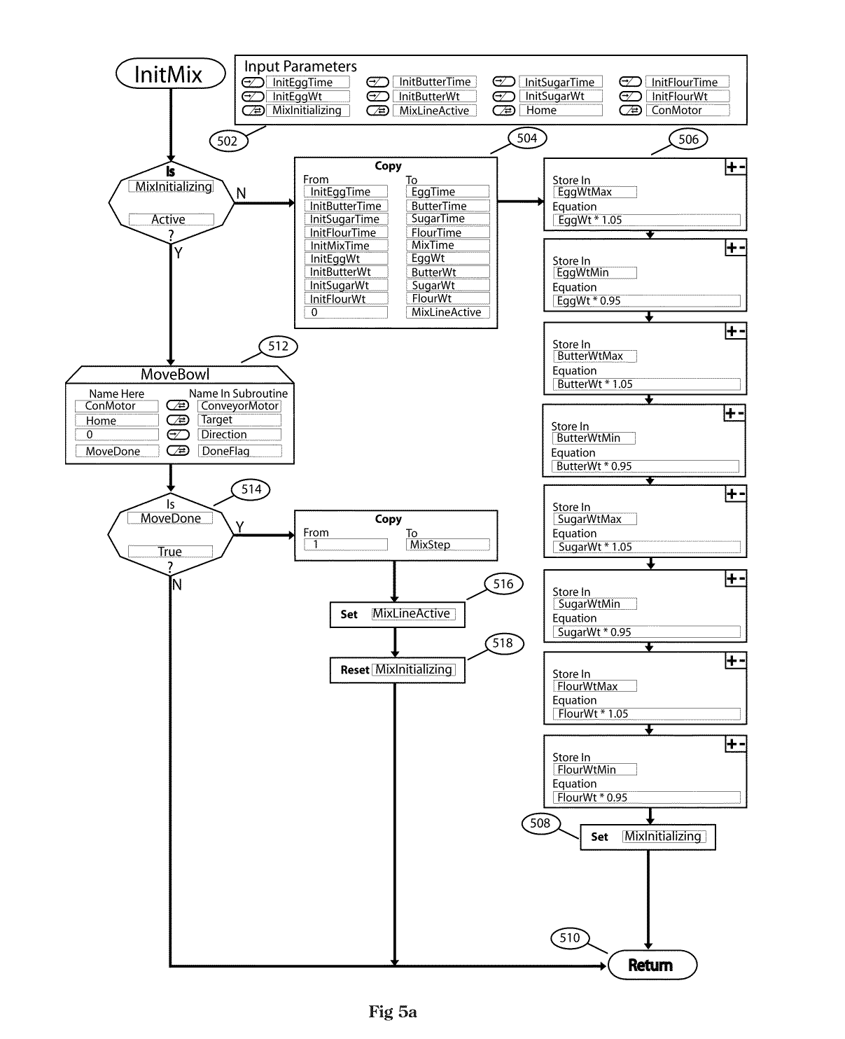

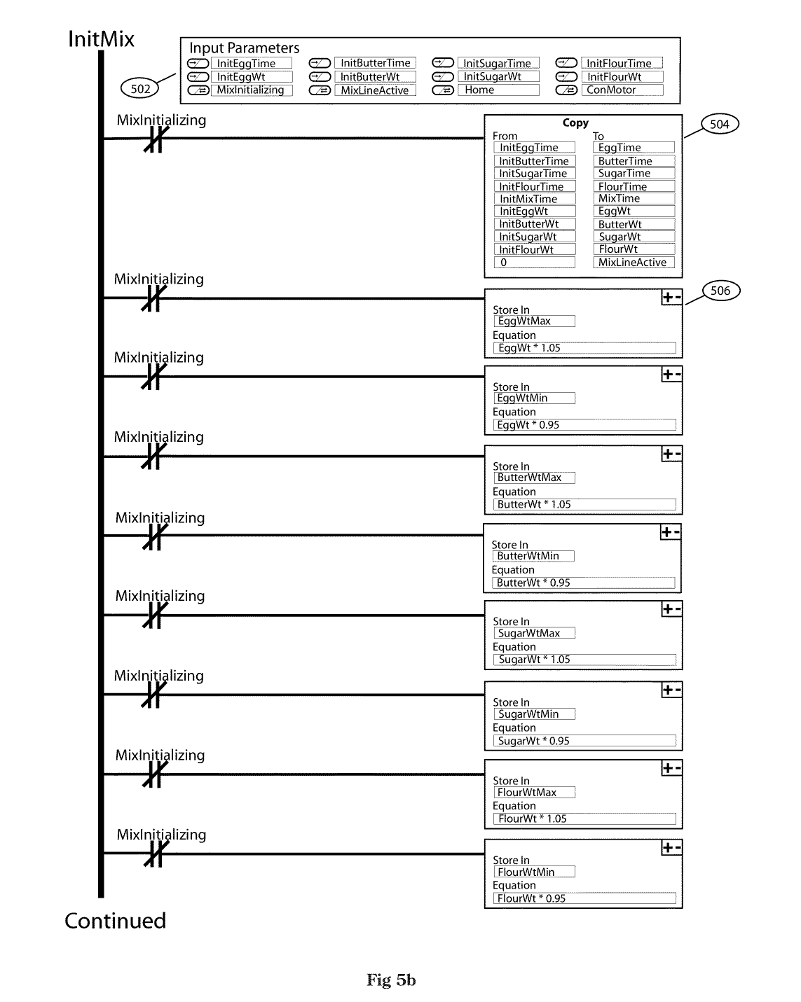

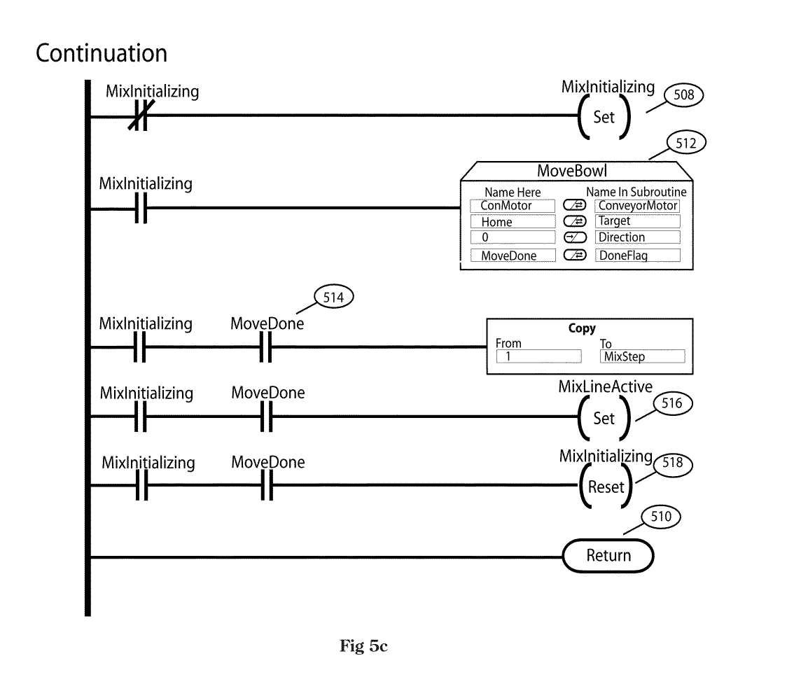

FIG. 5a shows the InitMix object subroutine implemented in flow chart programming. The list of input parameters is shown at the top of the program, item 502. MixInitializing is a bit that must be initialized to zero, or inactive by the program that calls InitMix. The first time InitMix is called, the subroutine will copy the recipe data into local object data, item 504, calculate operating limits, item 506, and set, or activate, the MixInitializing flag bit, item 508. The subroutine then returns, item 510, to the program that called it. The subsequent times the InitMix subroutine is called, another object subroutine, MoveBowl, item 512, is called to move the mix bowl to the Home position. The InitMix subroutine and the MoveBowl subroutine are written in a state machine fashion to allow other operations to occur while the initialization and bowl movement are happening. When MoveDone, a pass by reference flag which allows the MoveBowl subroutine to set its state, is true, Item 514, the IntMix will finish by initializing the MixStep to one, setting the MixLineActive bit flag to true, item 516, and resetting the MixInitializing bit flag, item 518, to indicate that the initialization process is complete. FIG. 5b and FIG. 5c show the same InitMix object subroutine implemented in ladder logic programming. The same item number references apply.

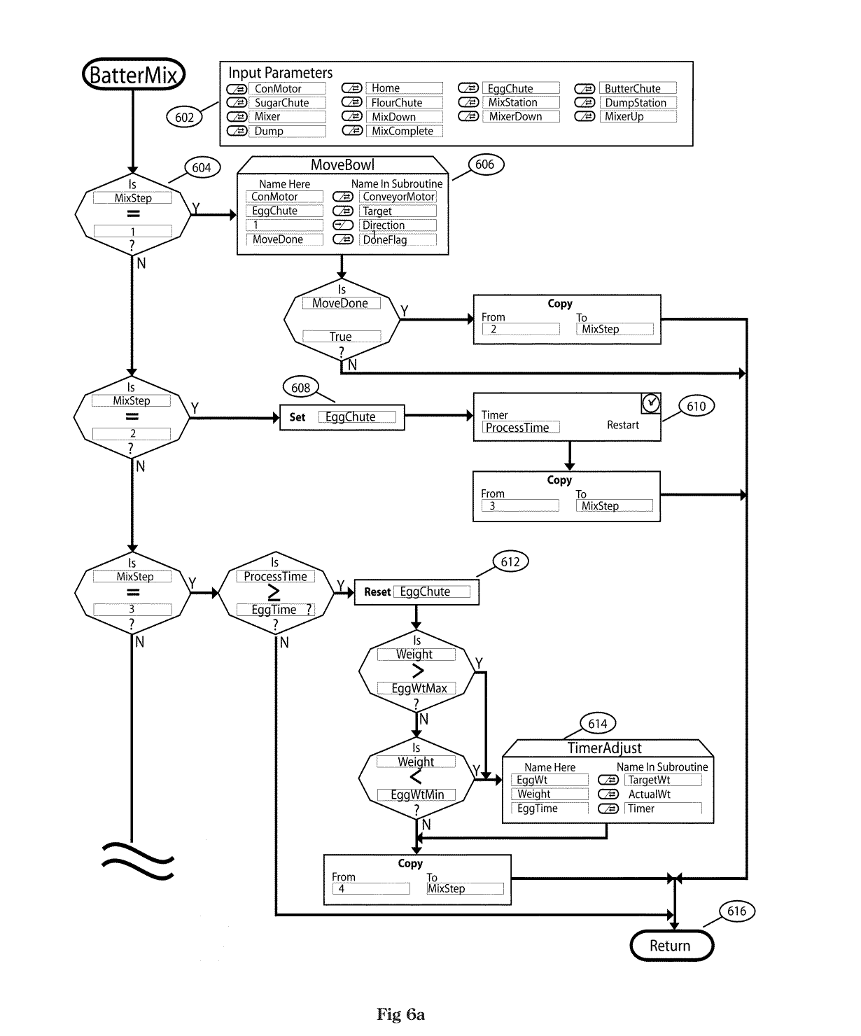

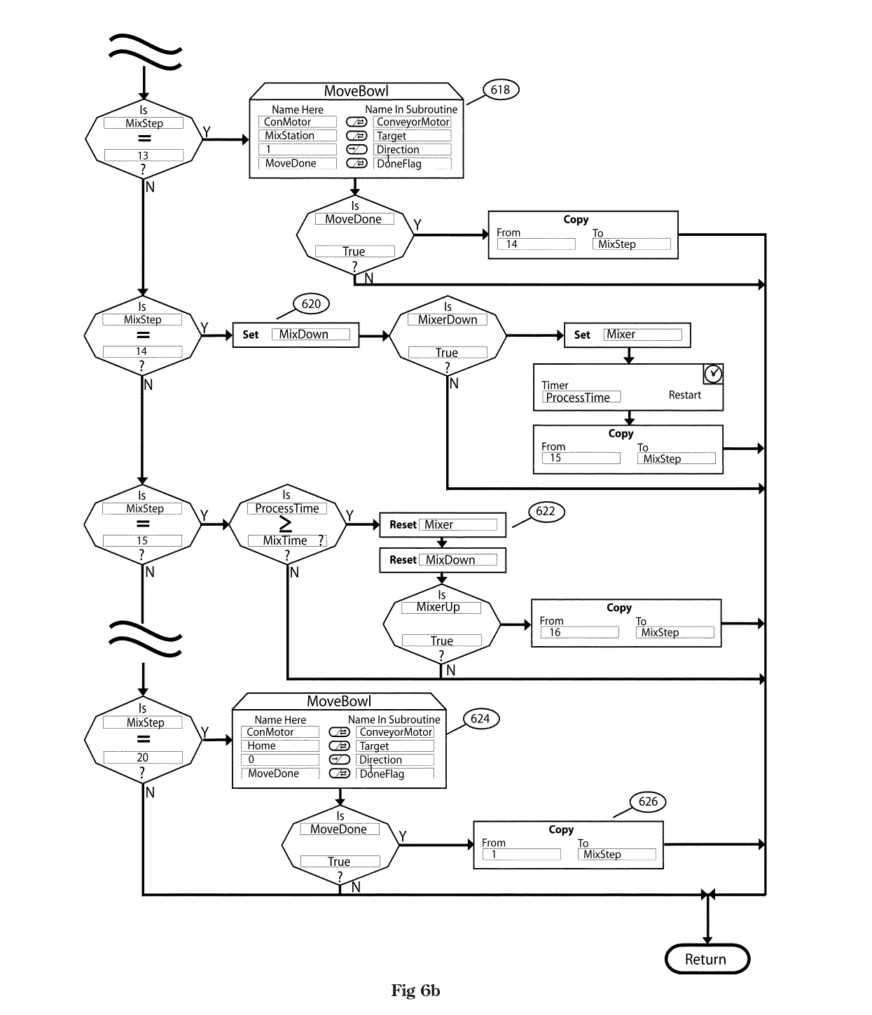

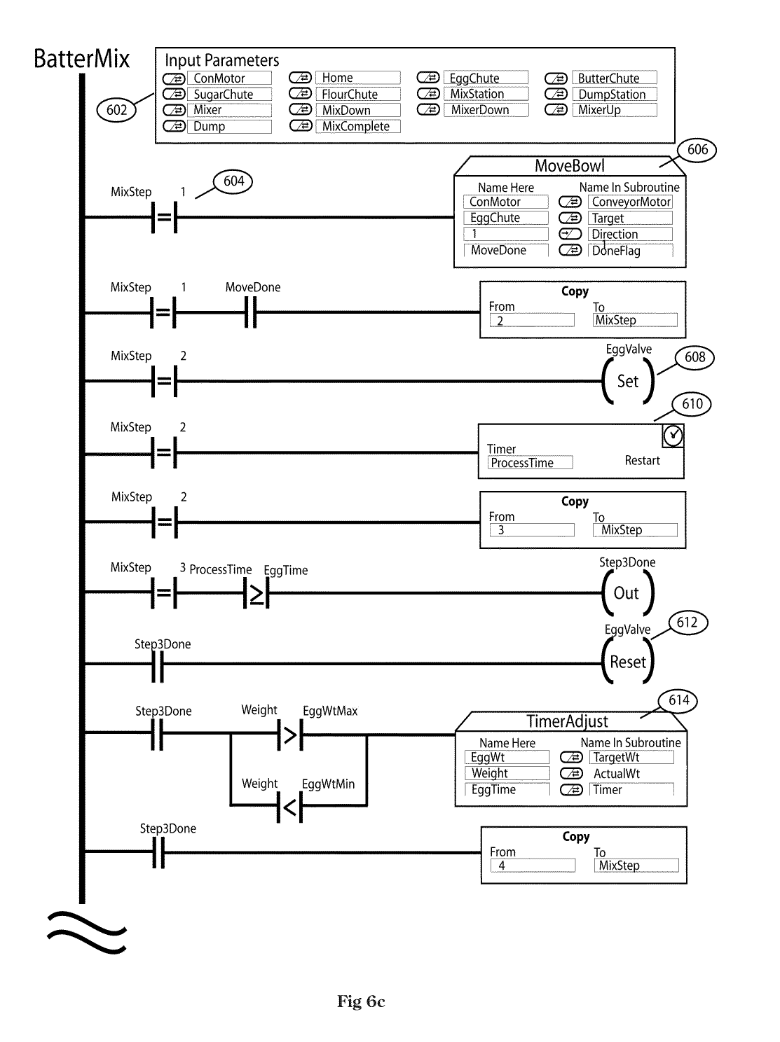

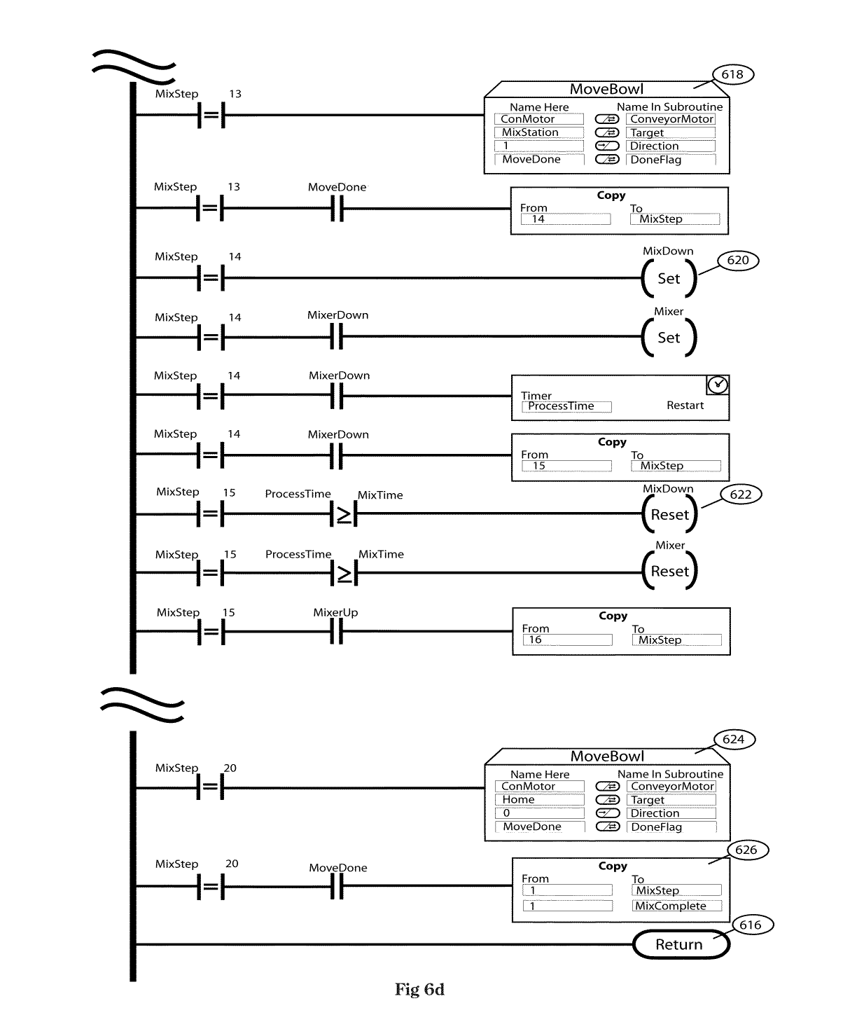

FIGS. 6a and 6b show the BatterMix object subroutine implemented in flow chart programming. The list of input parameters is shown at the top of the program, item 602. Since Flow Chart Programming is inherently self defining, the program will not be discussed detail by detail. Note that the subroutine is written in a state machine manner, using program steps, items 604 and those below, to allow other operations to be controlled by the PLC simultaneously. Each fill operation is performed by using a MoveBowl object subroutine, item 606, to move the conveyor to the proper position. The next step opens the fill valve, item 608, for the ingredient and starts a timer, item 610. In the next step, when the time value is reached, the fill valve is closed and the actual released ingredient weight is checked to see whether it is in range. If it is not in range, TimerAdjust is called, item 614, to adjust the release time value for the next batch. In this way each object self tunes its operation with its unique object data.

The BatterMix program would have the logic of steps 1, 2 and 3, repeated for each ingredient. FIG. 6b continues the program after all of those steps. The bowl is moved to the mix station, item 618, the mixer lowered into the bowl, 620, the mixer is turned on for the MixTime, and then the mixer is turned off and retracted, item 622. The final step is to move the bowl back to the Home position, item 624 and reset the MixStep to one, item 626, to enable the next mix operation. FIG. 6c and FIG. 6d show the same BatterMix object subroutine implemented in ladder logic programming. The same item number references apply.

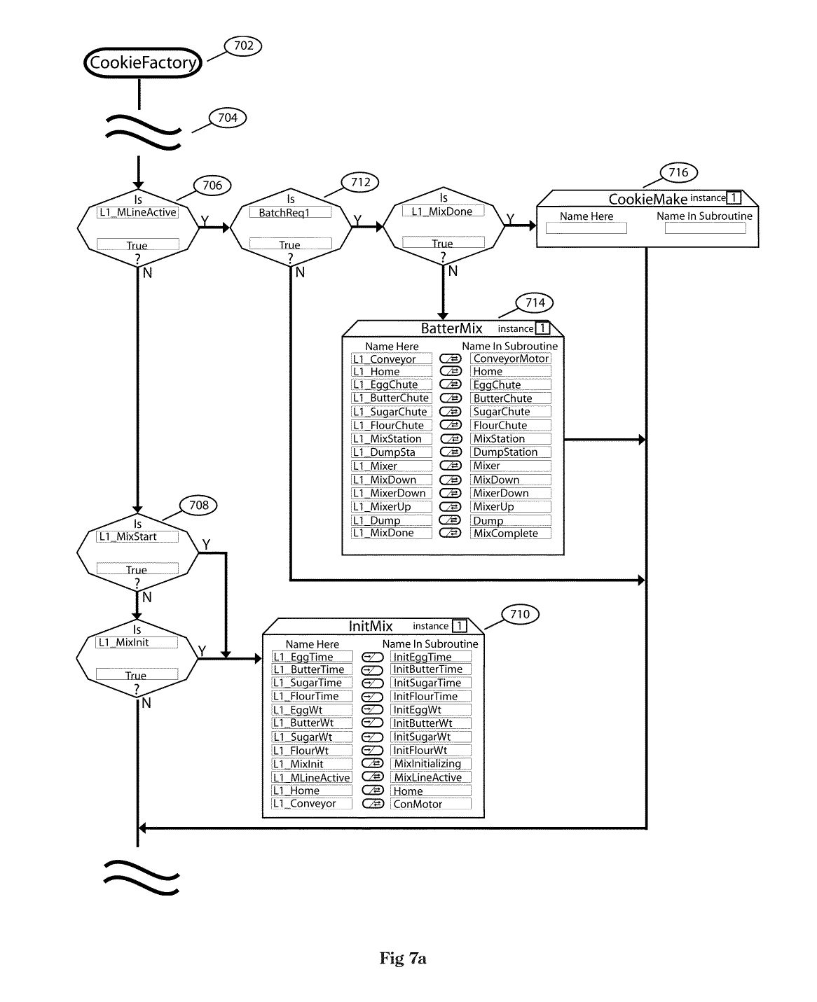

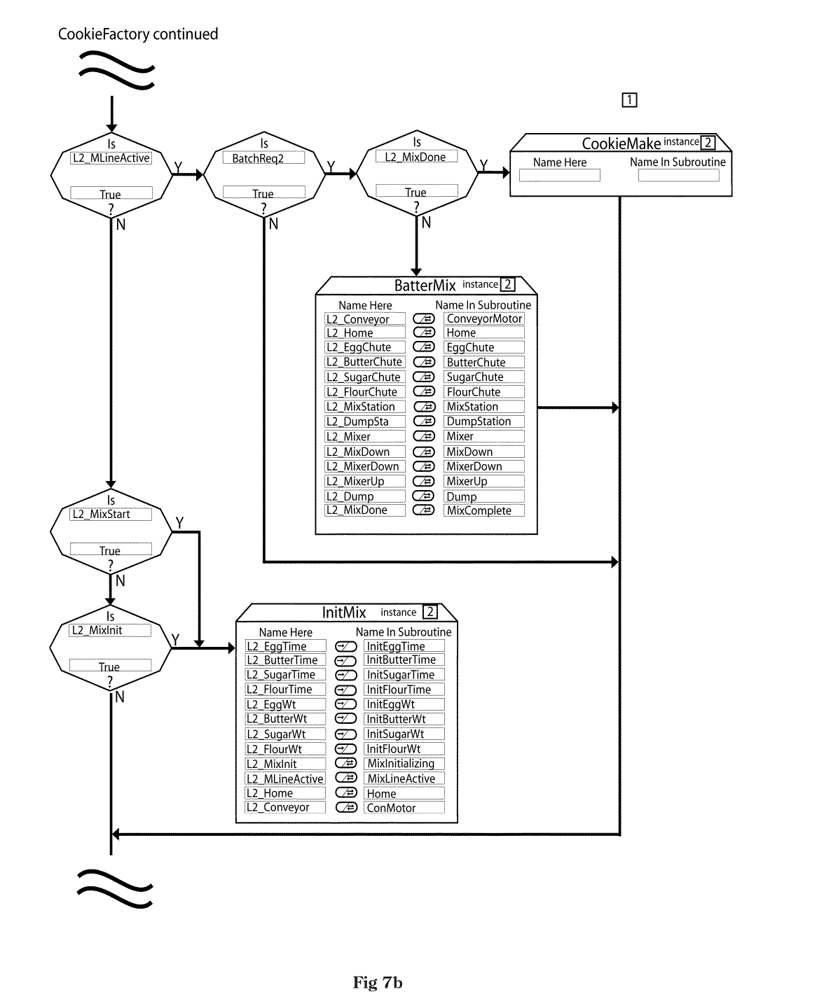

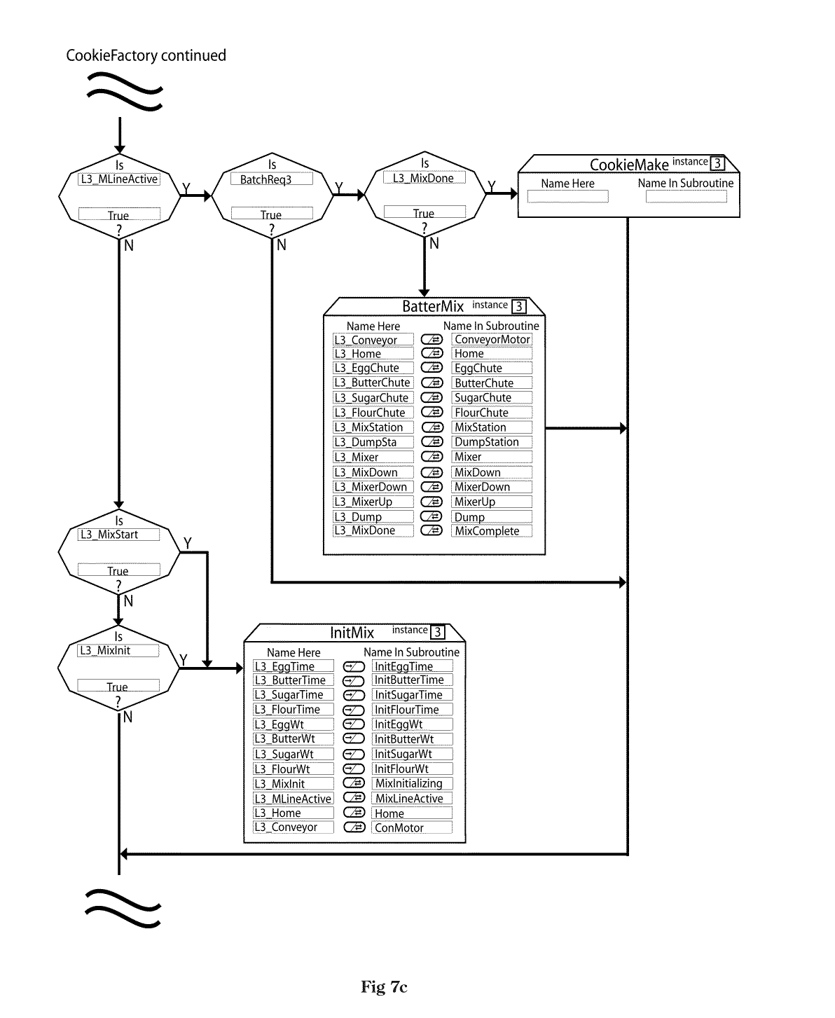

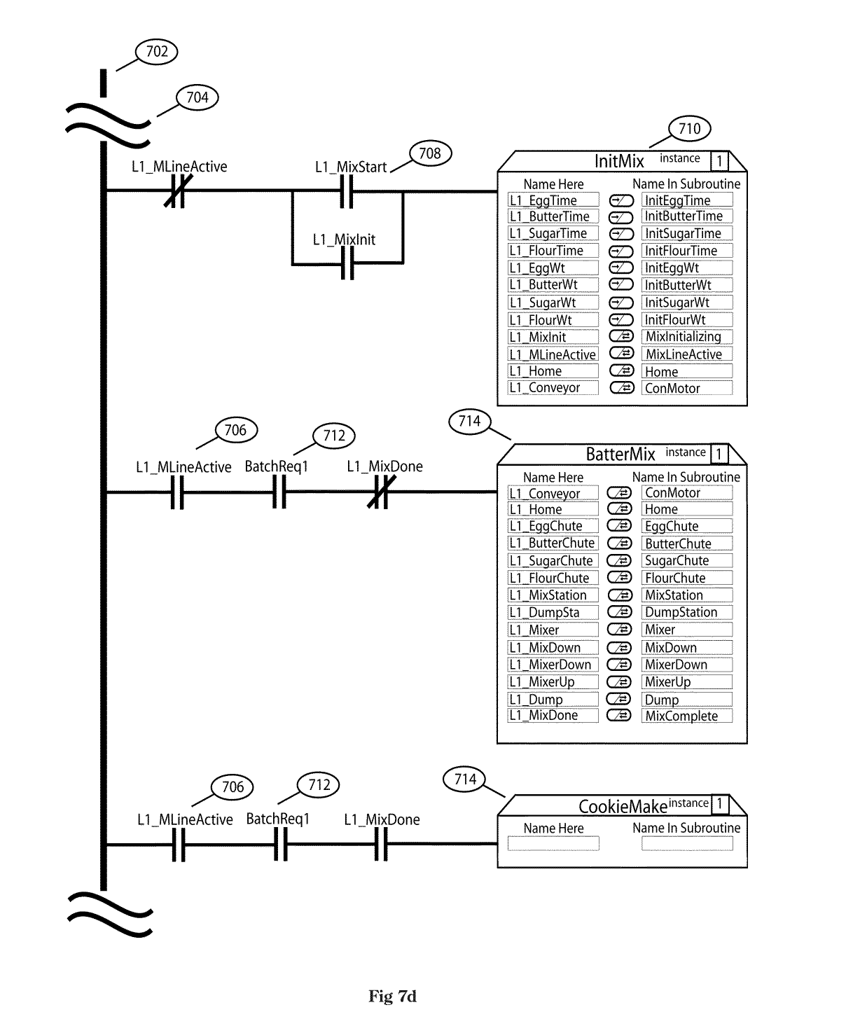

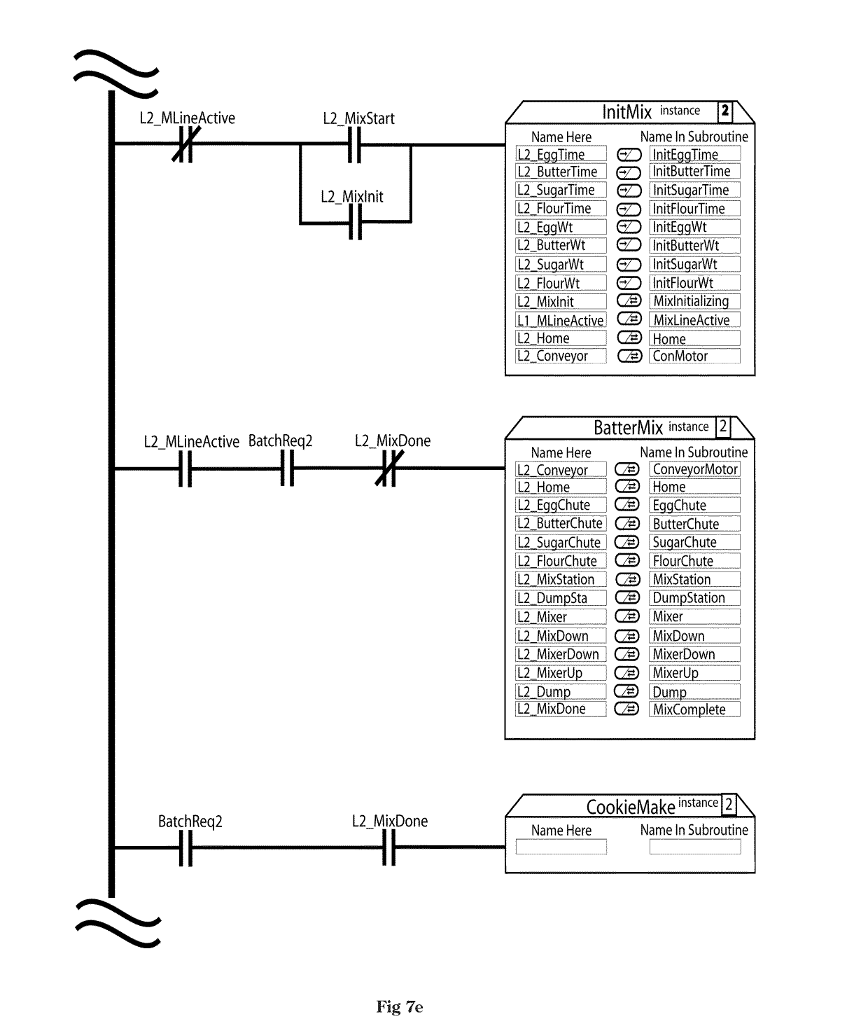

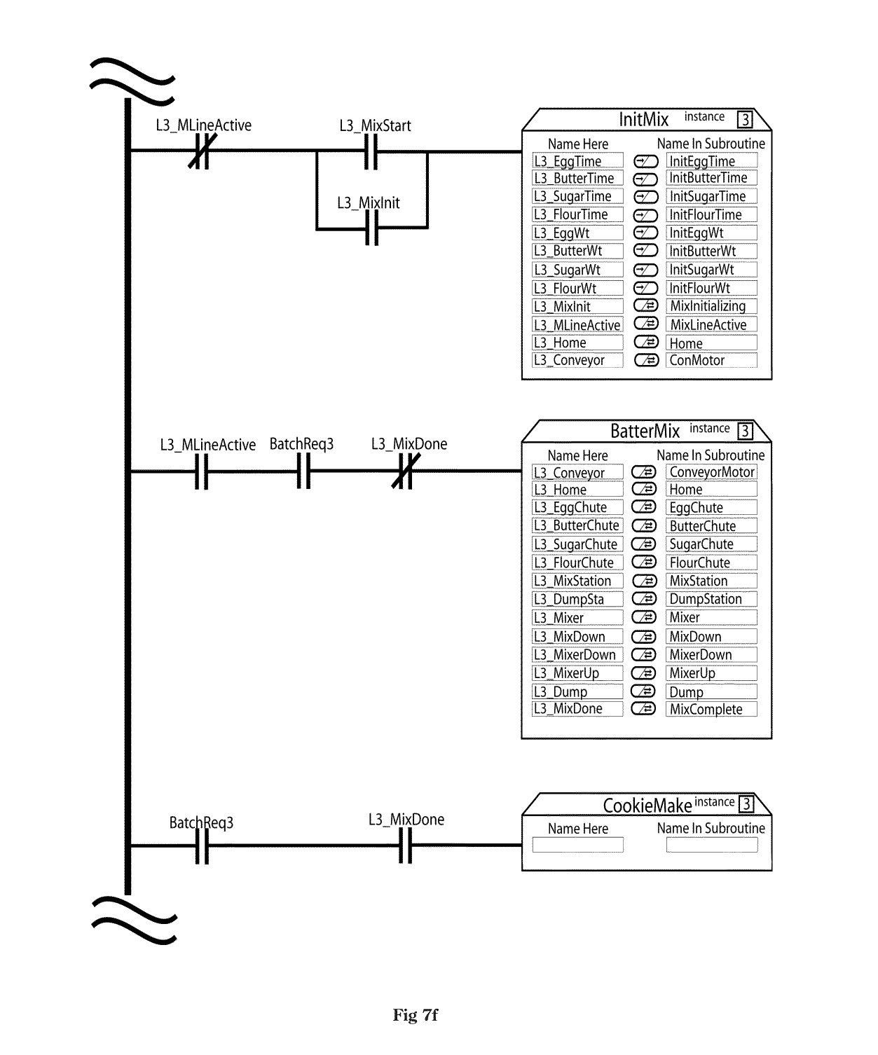

FIGS. 7a, 7b and 7c show a CookieFactory program implemented in flow chart programming. The cookie factory program likely controls a lot of functions besides the cookie lines. FIG. 7a shows the start of the CookieFactory program, item 702, program initialization and handling of other functions and logic, item 704, and the beginning of the program associated with cookie line one, 706. Manufacturing of cookies is handled by three object subroutines, InitMix, item 710, BatterMix, item 714, and CookieMake, item 716. Cookie line 1 activities start when L1_MixStart is set true by the main program. When it is, item 708, the InitMix is started and will continue until L1_MixInit is false. Notice that the data tag names passed in by the main program are different than the tag names used in the object subroutine. The main program tag names are linked to the object tag names in the object call, 710. Also notice that when the object subroutine is called, item 710, instance 1 is linked. Once the mix is complete, the line is active, L1_MLineActive, and goes into cookie batter mixing and cookie making mode. The BatterMix, item 714, is an object subroutine that we have already discussed. The CookieMake, item 716, is an object subroutine of another object. The call to the BatterMix passes all of the controls, such as EggChute, each time it calls the object. This was done to demonstrate data passing in an object subroutine call. A more efficient approach to the program would have been to pass the references in the InitMix call and create local object references in the object. That way the references would only have needed to be passed once.

FIGS. 7b and 7c show the same logic as that used for cookie line 1 applied to cookie lines 2 and 3. Notice that the associated object subroutine calls for line 2 link object data 2 and the calls for line 3 link object data 3. The squiggly lines indicate that there is other processing and control going on in the PLC application.

FIGS. 7d, 7e and 7f show the same application program written in ladder logic. The same item references apply.

### Extending to Embedded Objects

Embedded objects are defined as a program running on a separate processor, which operate in a very similar manner as regular objects. The embedded object has a data interface to its calling program, similar to that of a regular object. It can be implemented within a program as several different instances of the same object, each present on an independent processor.

There are some differences between an embedded object and a regular object. One difference is the passing of data between the calling program and the embedded object. Since the embedded object is running on a separate processor, program implementation can be set up to operate either synchronous with the calling program or asynchronously. If a synchronous operation is implemented, each program pass on the embedded object would be initiated by a message communicated from the calling program. The calling program would wait until the embedded object execution completes and transmits back return data, then proceed. This is the same sequence that occurs with a regular object.

A preferred implementation of embedded objects is asynchronous operation. With asynchronous operation, both the calling, or host, program and the embedded object execute at full speed without stopping to wait for the other. At the object call block in the host program, data transfer to and from the object are set up and transferred, respectively. The actual communications occurs asynchronously. In the embedded object, the data transfer occurs between program passes. Since there is no synchronization, the embedded object and its host, are loosely coupled. Depending on execution and data transmission speeds, actual data transfer may or may not occur each time the object call block is executed.

Data transfers defined for the embedded object could utilize the same pass by value and pass by reference definition as used by regular objects. To implement such a definition, every pass by reference would require transmission of reference data to the object and transmission of that same data back to the parent by the object. While this is possible and may be the implementation chosen by a given implementer, the preferred implementation is to modify the data interface for embedded object to pass by value in both directions.

Another aspect involved in implementing embedded objects is the desirability of monitoring the presence and identity of attached embedded objects by the host and monitoring communications status on both sides. With such monitoring, both the host device and the embedded object keep track of whether valid communications has occurred within a predefined time frame which defines active communications. If such communications is active, the host device is aware of the object's identity and the status of the communications link. Such information allows a program developer to define operation based on presence or absence of the object. An extension of that capability enables the implementation of “plug and play” functionality. From the embedded object perspective, communications status can be used to determine the appropriate program operation of the object. For example, the application developer can program the object to perform either an orderly shut down or continued independent operation upon loss of communications with its host.

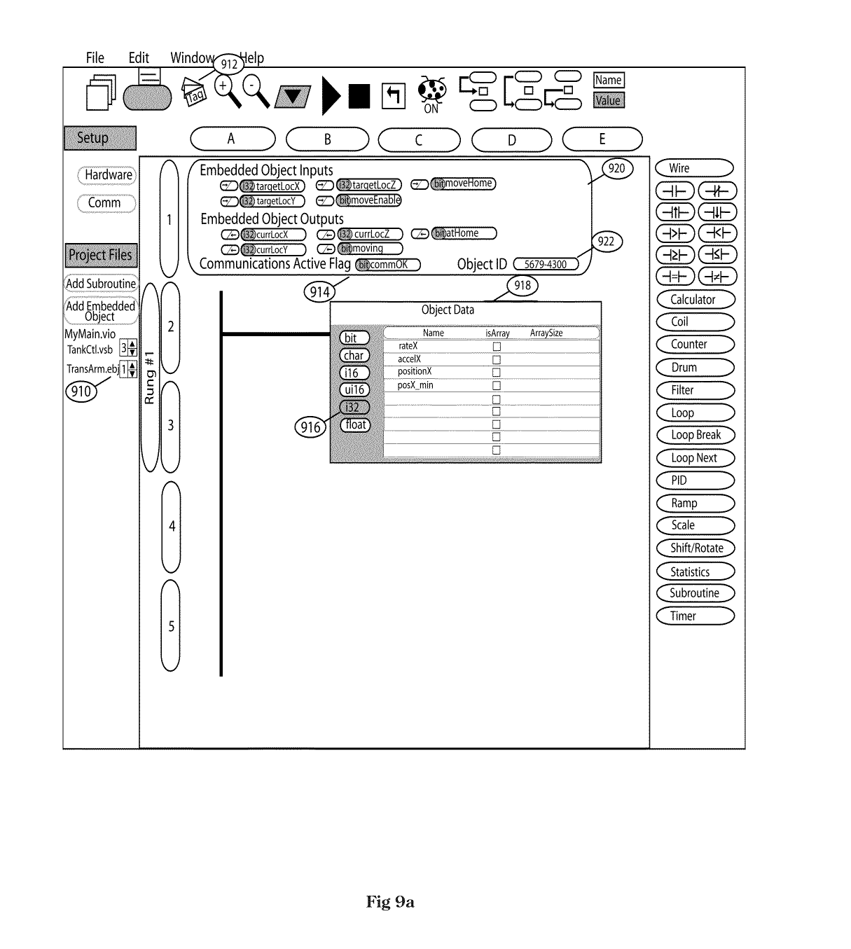

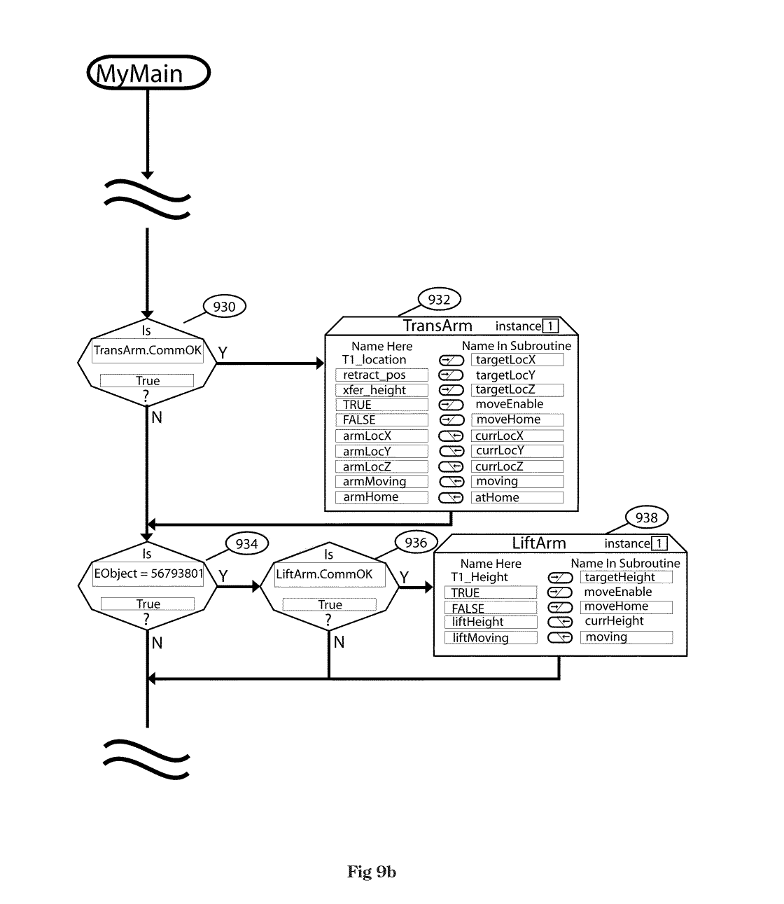

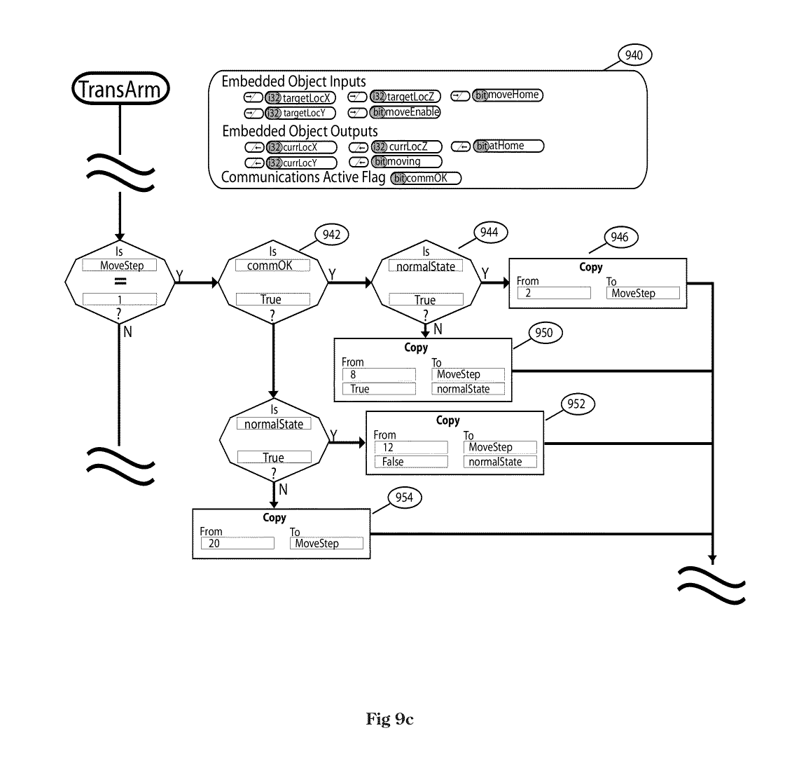

The data definition associated with the entry of an embedded object is shown in FIG. 9a. Initial selection of the addition of an embedded object subroutine is basically the same as the for regular object subroutine, as previously illustrated in FIG. 2 and discussed above. FIG. 9a shows the entry of an embedded object, shown as TransArm, item 910. The data interface between the host and the embedded object is defined in an Input/Ouput definition block shown as item 920. Each embedded object type can be assigned a unique identifier, item 922, which will be transmitted to its host during communications to identify exactly which embedded object is attached. The figure illustrates the preferred asynchronous operation embodiment. The data definitions are pass by value type in both direction. The Input/Output definition block also incorporates a communications active flag, which is available to both the parent and the embedded object to indicate the state of the communications interface. All local object data is defined the same way as for regular objects. Selection of entry of object data begins with the selection icon, item 912, which brings up an object data definition window, item 918, which can be used to enter the definition of all object data.

FIG. 9b shows a typical embedded object call from a host program. The communications status flag can be checked prior to a call, item 930, in order to determine program operation. If communications is OK, the embedded object call occurs. The call block, item 932, transfers data to be sent to the object to a transmit buffer and enables transmission. If data is available from the object, it is transferred to the host tags identified in the object call. If the object communications is not active, the host program can be written to perform some other logic. Block 934 performs a check to determine whether a particular embedded object is present. If the object that the program is looking for is present, communications is checked, block 936, and the call block 938 performs the data transfer. This conditional operation based on the presence or absence of an object is the basis of plug and play. If a device is present the program uses it. A program could be written to respond to the presence or absence of any number of potential embedded objects.

FIG. 9c shows a typical embedded object program. Item 940 is a list of the data transferred from and to the host. Since communications with the host is subject to being active or inactive, and can change during operation, a typical program implementation would regularly make operational decisions based on the status of communications with the host. Block 942 shows a fundamental operational decision being made based on the status of communications. Block 944 is an example of a secondary decision based on whether there has been a recent change of status. Blocks 946, 950, 952 and 954 illustrate operation based on status and change of status. Exactly how a particular embedded object operates with and without communications with the host is something that is determined by the application developer.

Actual communications of program data between the host and embedded object occurs asynchronously, while other operations are occurring. During debug operations, any embedded object data that is being monitored and commands sent from the development and debug system is communicated in the same manner between the host and embedded object. The host handles the data and command interface with the development and debug system.

Programming and debug of an embedded object can occur either independent of the host or through the host. The preferred embodiment is through the host. With an embodiment which performs programming, and debugging through the host, the entire application, including embedded objects can be developed, debugged and validated as one integral unit. There are cases where object development may occur separate from the host program. The invention of embedded objects enables the development of standard objects, which can be developed and sold as standard objects. In such a case, the host program simply incorporates and uses a standard object. The preferred embodiment would enable the development system to query the object to determine the data interface.

The mechanism for communications between the host and embedded object can take many different forms. Traditional PLC architectures incorporate a backplane with control, data and address lines to transfer data and messages between the main CPU and subordinate devices. Newer architectures perform the same type of task over serial backplanes or serial communication links. The keys are that the host and the embedded object are two separate processors that communicate via some method to provide control oversight, program download, debug support, and data transfer.

### Implementation of the Preferred Embodiment

Implementing object oriented programming in graphical PLC languages requires design of a development and debug system which allocates object memory, allows the linking of object memory to each subroutine call and has operation integration functionality with the target PLC to enable program download, debug and control over the PLC. The PLC design must incorporate integrated operation with the development and debug system to download programs, execute logical operations linked to the object data defined by the development system, provide for debug operations and allow for control from the development system.

Extending to embedded objects requires the design of the host device to communicate control, program download and data transfer to the embedded object and the design of the embedded object for corresponding operations.

The program entry on the development system have already been discussed and illustrated in the preceding text and FIGS. 2 through 7.

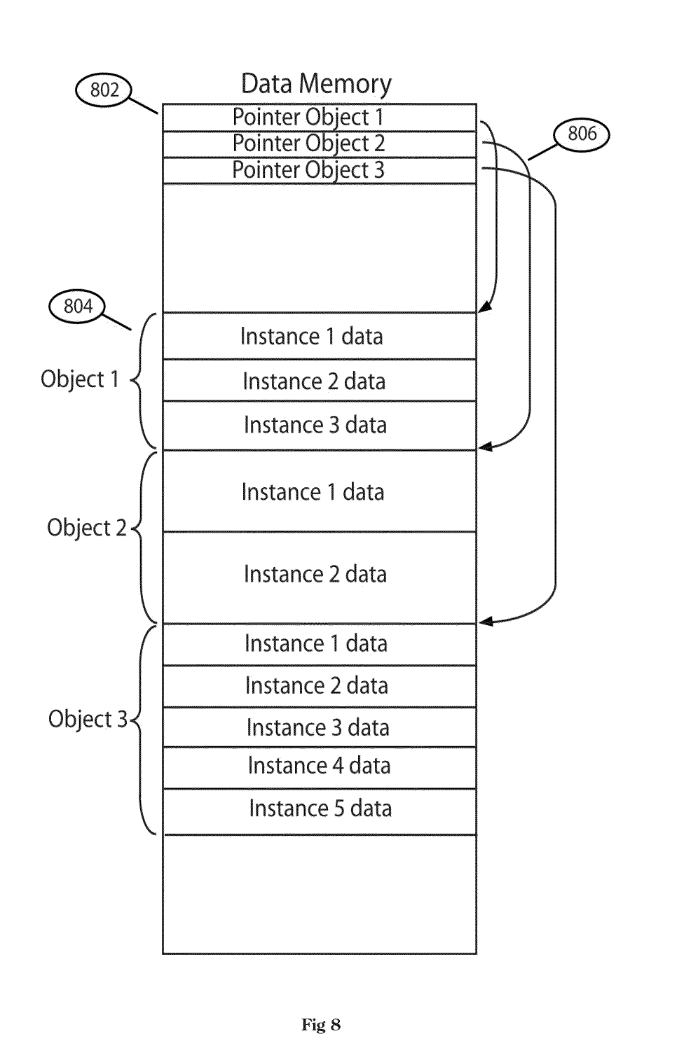

When the development system compiles the application program, it must allocate object memory for each instance of each object defined in the application program. FIG. 8 illustrates object memory allocation. Each instance of each object is allocated a block of memory, item 804, required to store all of the object data defined for the object. The amount of memory allocated varies and is determined by the total of all of the data items defined as object data. For example, a character data item requires one byte, a 16 bit integer requires two bytes, a floating point number requires four bytes. Each object data item is identified in the execution code as an offset from the instance base address. A table of object pointers is created, item 802, that points to the first instance of the object, item 806. Other instances, item 804, are located by the location of the first instance plus the size of the object data times the instance number minus one. An equally preferred embodiment option is the creation of a pointer, in the object pointer table, for each instance of each object. In that embodiment option, the instance data pointer is located as the base pointer location of the object type offset by the instance number minus one.

Object subroutine input data can be implemented on a data stack. A data stack is the most common method for handling passed data in computer software and requires no explanation for software professionals.

Object data, including input and output data, as well as object static data reside within an embedded object. The allocation of embedded object data can be implemented as allocated block data, as described for non-embedded object data. A preferred embodiment would allocate the embedded object data as the embedded object's global data memory and any local objects called by the embedded object as allocated blocks. Embedded objects can call local and embedded objects. Therefore, the hierarchy can extend to any level.

### PLC System Operation

The following paragraphs discuss the logical operation of the main program and key functions of the PLC. The following text describe the firmware that oversees, enables, downloads and provides supervisory control over the application developed using the debug and development system.

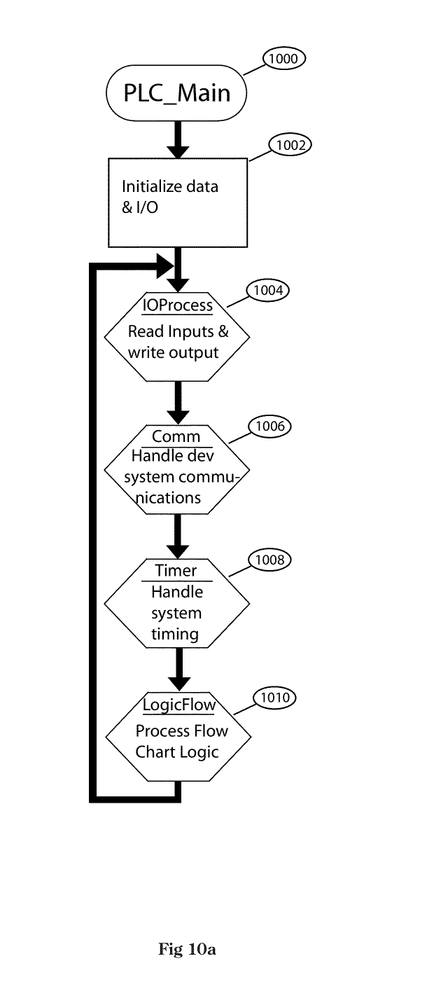

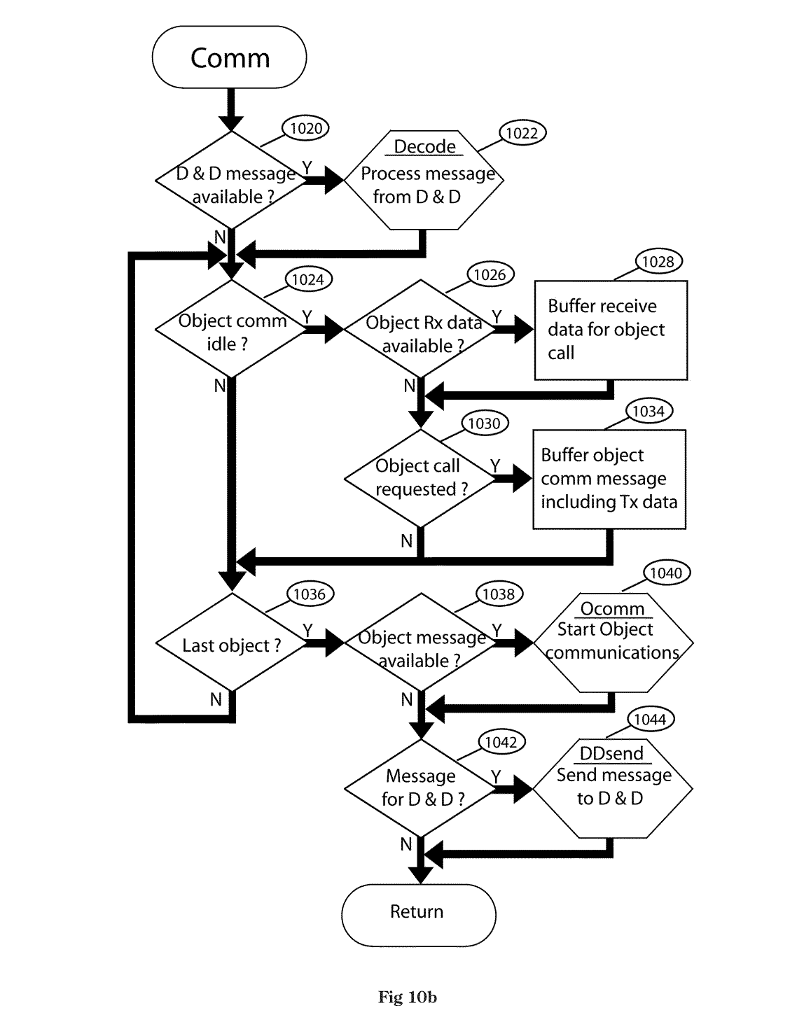

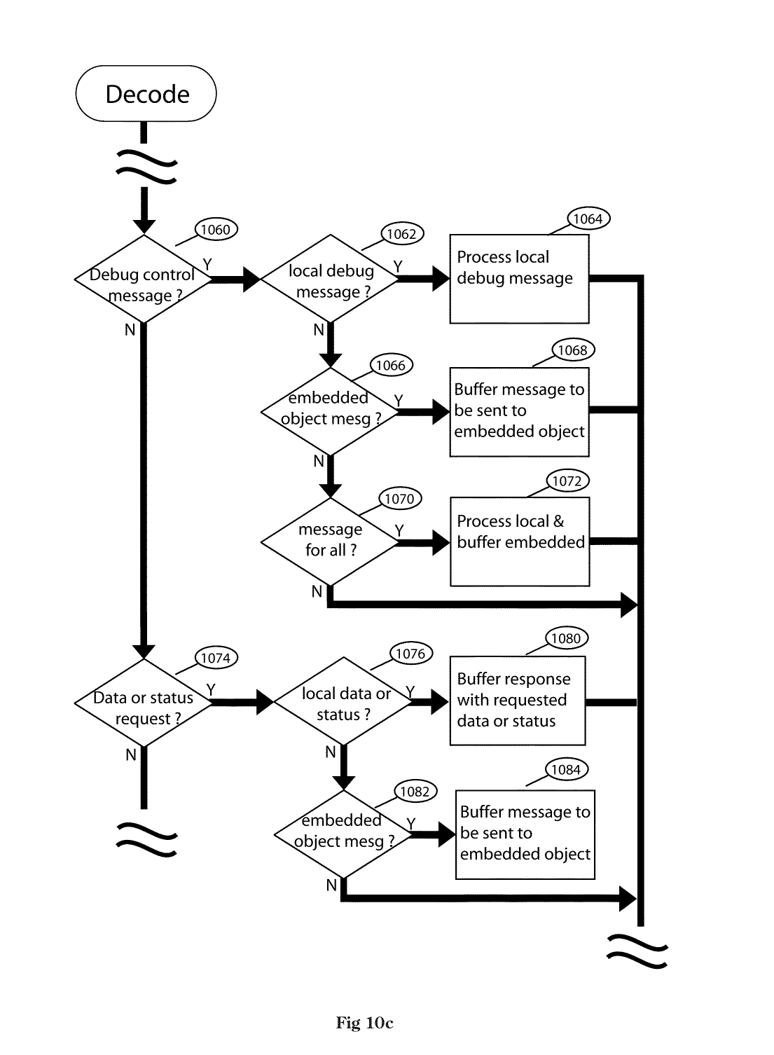

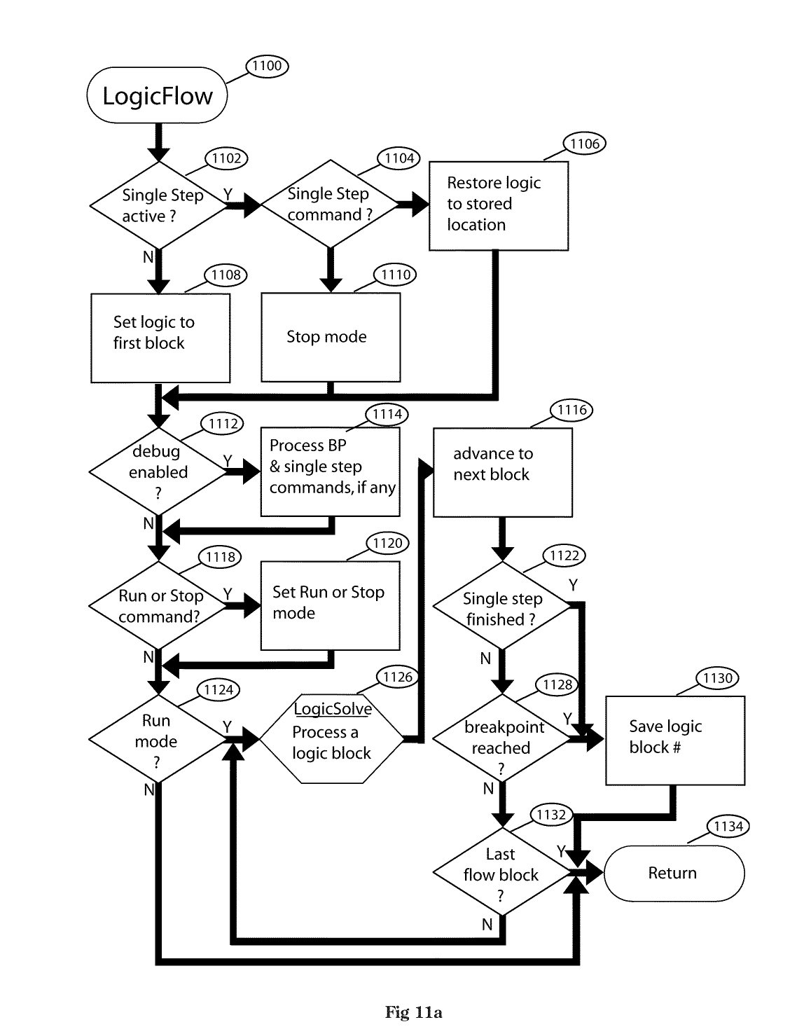

FIG. 10a defines the main program of an implementation of a target PLC. The PLC program operates in a continuous loop. The main program handles the loop operation and calls subroutine functions to handle major operational details. An alternate implementation might be the use of a multitasking operating system, which periodically switches between the key function tasks.

The PLC program executions starts at FIG. 10a block 1000. The first operation performed is the initialization 1002 of all data and I/O in the PLC.

In the illustrated implementation, the PLC goes into a super loop operation. In the implementation shown, each pass will read inputs, adjust output signals and perform other instrumentation activities in IOProcess, shown as item 1004.

In item 1006, communications is handled. Communications includes messages between the PLC and the Development and Debug System. For embedded objects, the communications function also communicates all necessary data between the main program and the embedded object subroutines. If there are other system communications capabilities, that communications is resident here, as well. Whenever executable code is downloaded from the Development and Debug System, the Communications function of the target system will handle the download and the set up for execution.

Block 1008 handles system timing. This would include the time base for timer blocks in the application logic flow.

The heart of the PLC operation is shown as the LogicFlow function in item 1010. LogicFlow and its subroutines handle the execution and debug of the application executable code.

FIG. 10b illustrates the logical operation of the Comm routine, which handles communications with the development and debug system, as well as with any embedded objects. The logic first check, item 1020, determines whether any message from the development and debug system is available. If there is a message, it calls subroutine Decode, item 1022, to process the message.

Object communications can occur over any type of communications link, including parallel or serial backplane, SPI cable, serial UART, Ethernet, or anything else. A PLC design can also implement more than one type of communication link to embedded objects. If communications is over a parallel connections, it is likely that all communications will occur completely as reads and writes within the Comm routine. If it is a serial connection, it may require more time for message transmission. In order to not delay other processing, serial transmit and receive messages are started and processed within the Comm routine and occur in the background through interrupt operations. In any case, the logic shown in FIG. 10b applies.

FIG. 10b, item 1024 checks to see if object communications is idle. For parallel backplane implementations, it will be idle. For serial implementations, communications started on a previous pass may not be complete, and therefore not idle. If idle, a check is made, item 1026, to see if received data from the object is available. If a message is available, it processes it, item 1028. The message could be object receive data, which would be buffered for the next time the object call block is executed. It could also be a response to a control, debug or status request message from the development and debug system, which would result in a message buffered for transmission to the development and debug system. A check is made, item 1030, to determine whether a message is buffered for transmission to the object. Such a buffered message could be one sent from the development and debug system and processed by the Decode routine. It could also be an object data message buffered by the object call block of the application program. If there is a message, the message is buffered to send in item 1034.

Whether the communications link to the object is not idle, item 1024, or is processed, items 1026, 1028, 1030 and 1034, a check is made to see if there are any more objects in item 1036. If this is not the last object, the process repeats for the next object. If all objects have been processed, program flow continues to item 1038. Item 1038 checks whether any messages are buffered to send to objects. If messages are available, Ocomm, item 1040, is called to start data transmission and evoke response communications from the objects. Next, item 1042 checks whether there is a message available to be sent to the development and debug system. If there is a message to be sent, DDsend, item 1044, is called to start transmission to the development and debug system.

Pertinent logic for the Decode routine is shown in FIG. 10c. If the development and debug system sends a debug control message, such as a single step, breakpoint or run command, item 1060 will detect it and pass program flow to item 1062. If item 1062 determines that the message is for this device, item 1064 will process it. Processing will generally result in commands and data being set up for action by the LogicFlow routine. If the message is for an embedded object of this device, item 1066 will detect and pass control to item 1068 to buffer a message to pass to the object. If the message is one, such as a stop all or start all, which pertains to both this device and its objects, decision item 1070 will transfer control to item 1072, which will both process for local action and buffer messages to embedded objects.

Data and status request messages are handled in a similar manner. When a data or status request is received, item 1074 will pass program control to item 1076. If the request is for local status or data, item 1080 will buffer a response message. If it is for data or status from an embedded object, items 1082 and 1084 will detect and buffer a message for the embedded object.

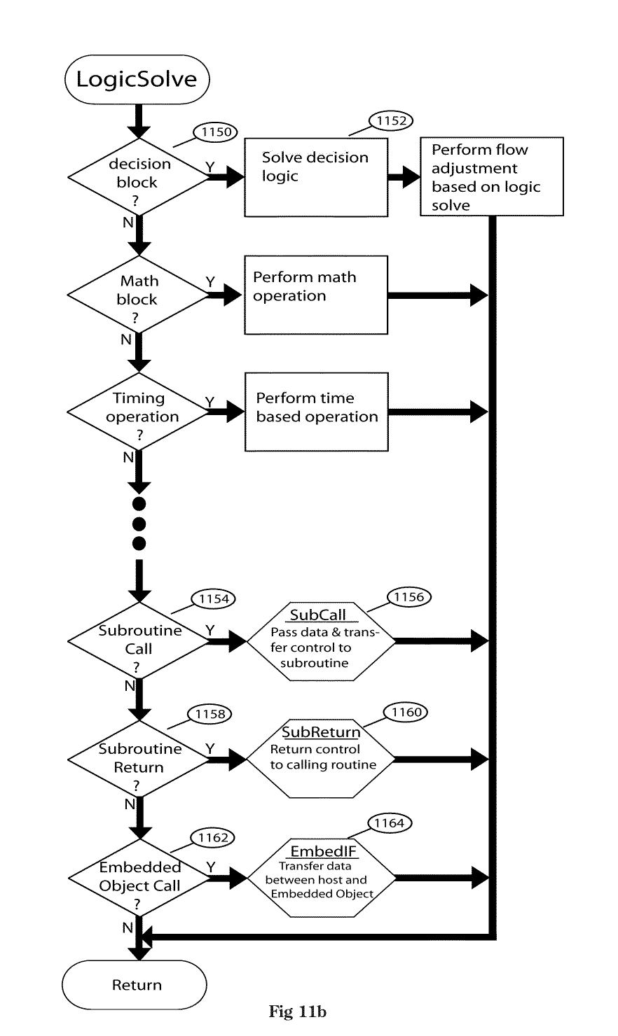

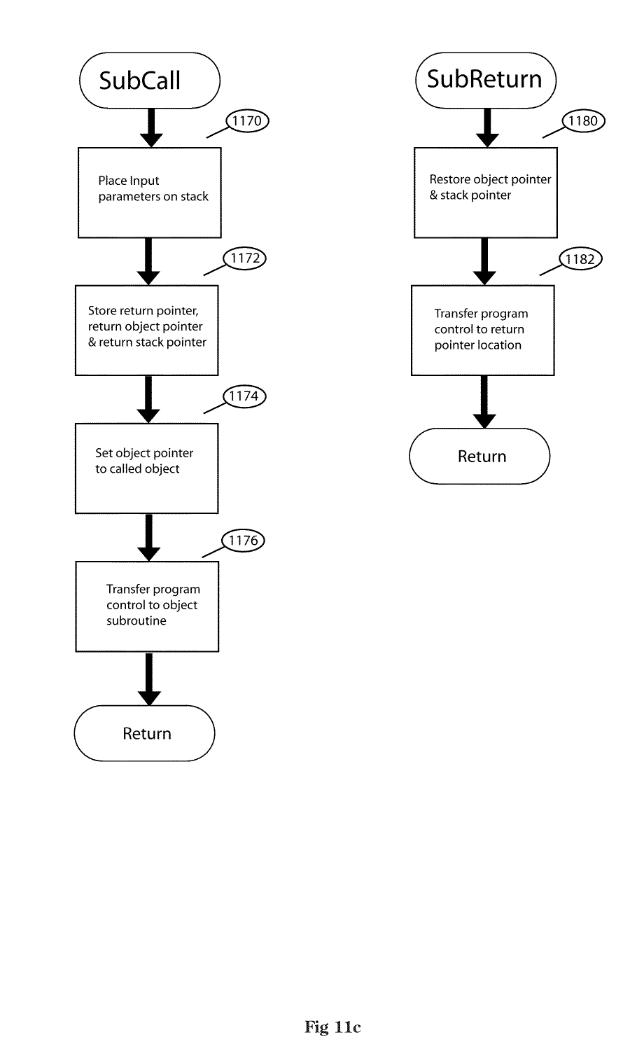

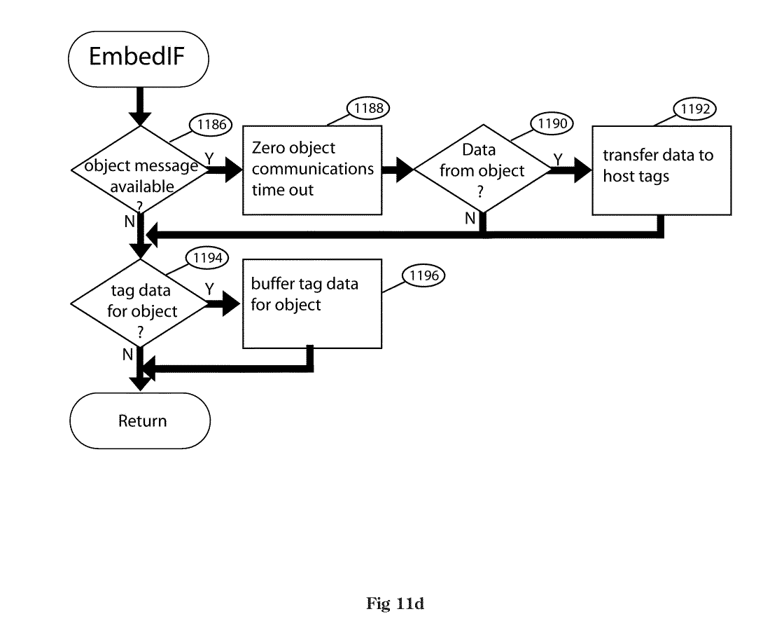

FIG. 11a defines the core logic for LogicFlow, the primary supervisory control program overseeing the PLC operation. When LogicFlow is called, it starts at item 1100.

The majority of the program logic defined by the 11a flow chart is the logic required to implement execution and debug functionality. Items 1102, 1104, 1106 and 1110 control the process of allowing the application programmer to single step, function block by function block, through the application program. Items 1112 and 1114 handle responding to the application programmer selection on the development system entering program break points and single step commands. Item 1118 and 1120 respond to the application programmer selecting a Run or Stop operation from the development and debug PC.

If the PLC has been placed in the Run mode, either as a single step or full run mode operation, item 1124 will cause program execution to call the LogicSolve function, item 1126 to process one application program block. Following the processing of the application program block operation, items 1116, 1122, 1128 and 1130 handle advancing the program and stopping execution due to single step or breakpoints being reached. If single step operation is not active and no breakpoint is reached, item 1132 will either return processing to the next application program block or, if all blocks have executed, return to the TargetMain program.

The LogicSolve function, which processes all function blocks, handles transfers to and from object subroutines and interfaces embedded objects is shown in FIG. 11b. As the figure shows, general function processing is a matter of determining what type of application function block is selected, item 1150 and performing the selected operation, item 1152. This operation applies to coils, contacts, copy operations, timing, math, PID functions and any other logical function block resident in the PLC implementation.

An object subroutine call is shown as items 1154 and 1156. When the next required application program block to be process is an object subroutine call, LogicSolve decodes it, item 1154, and calls function SubCall, item 1156, to transfer data and control to the object subroutine. SubCall is shown in the left hand side of FIG. 11c. The process of transferring control to an object subroutine starts with putting the input parameters on an execution stack to be used by the subroutine, item 1170. Next, pointers to the current object data, block to return to after execution of the object subroutine and pointer to the input parameter data for the current object are stored, item 1172. Next, the object data pointer is set to the called object, item 1174. Lastly, program control is transferred to the first block of the object subroutine.

The return from an object subroutine is shown on the right hand of FIG. 11c. The return operation restores the object pointer and stack pointer to the object subroutine or main program that called the subroutine. That is followed by transfer of program control to the return pointer location.

FIG. 11d illustrates the logic involved in a program call to an embedded object, such as the one shown in FIG. 9, item 932. A program call to an embedded object is the transfer of data passed via communications which has been discussed with respect to FIG. 10b and FIG. 10c. FIG. 11d shows that logic begins with a check, item 1186, to determine whether a message is available from the embedded object. If a message has been received, item 1188 resets the object communications time out timer. So long as the timer is below a threshold value communications with the object is regarded as communications OK. Item 1190 checks whether data has been received from the object. If data has been received, item 1192 will transfer the data to the appropriate host tag variables. Item 1194 shows a check to see if data is to be sent to the object. If data is to be sent, item 1196 will place it in the buffer set aside for data to be transferred to the object. Actual communications can occur over a variety of synchronous or asynchronous communications mechanisms, which have been discussed previously.

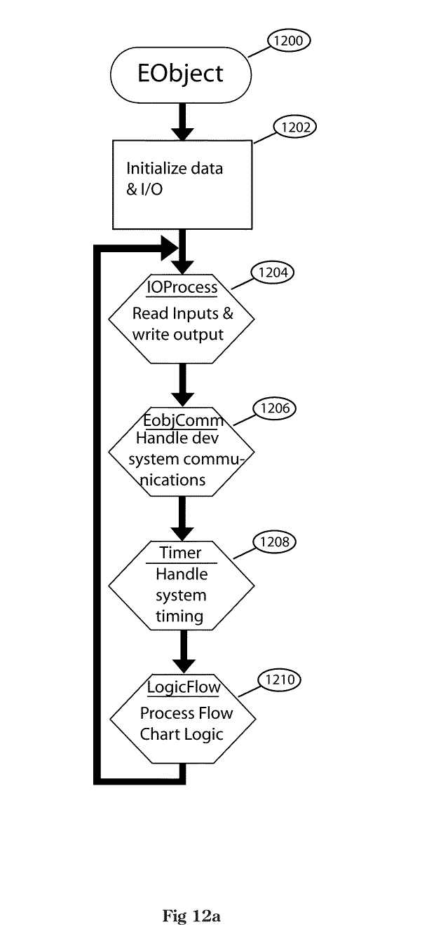

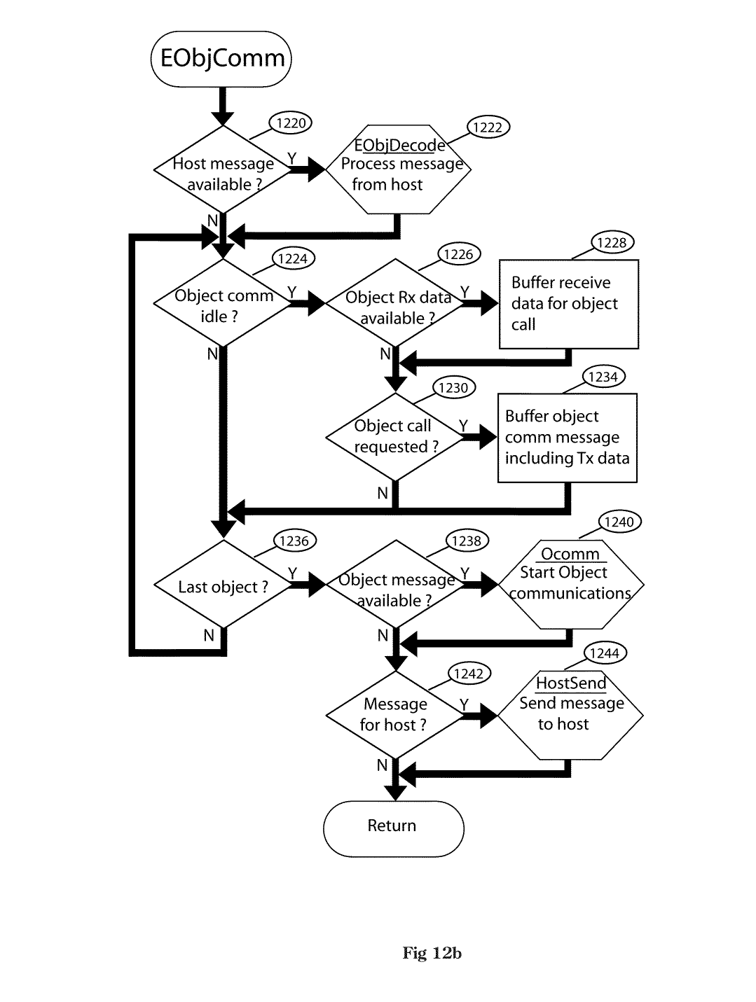

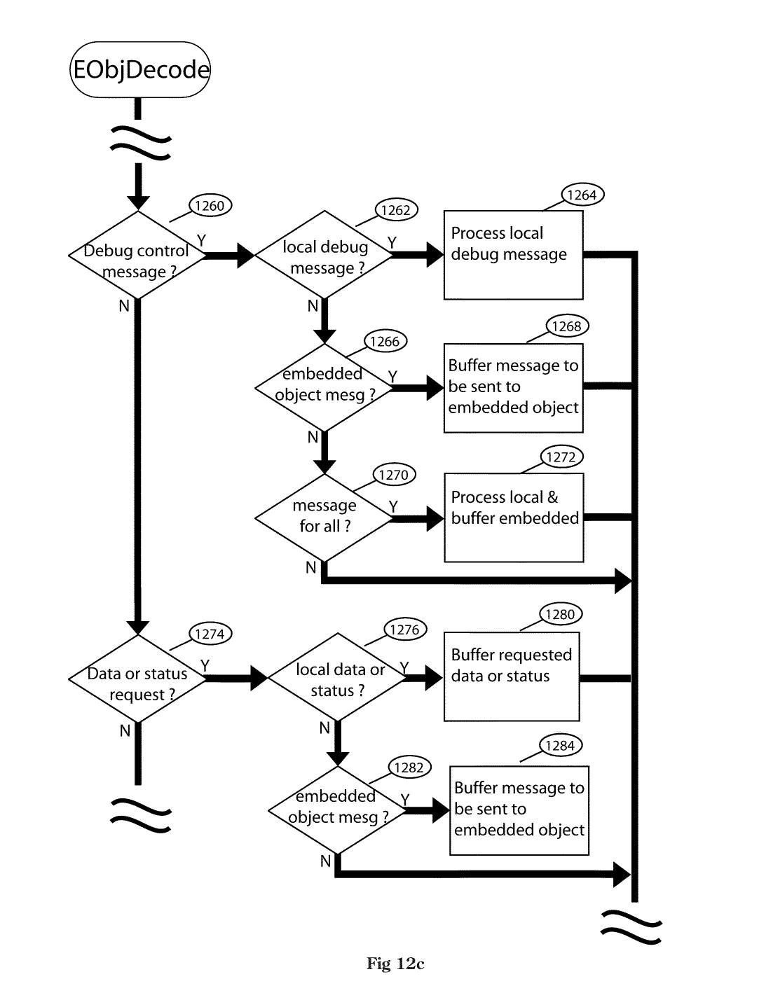

The logic for the embedded object is nearly identical to that for the host PLC. The main program for the embedded object is shown in FIG. 12a. The first operation performed is the initialization 1202 of all data and I/O in the Embedded Object.

In the illustrated implementation, the Embedded Object goes into a super loop operation. Like the host PLC, an alternate implementation might be the use of a multitasking operating system, which periodically switches between the key function tasks. In the implementation shown, each pass will read inputs, adjust output signals and perform other instrumentation activities in IOProcess, shown as item 1204.

In item 1206, communications is handled. Communications includes messages between the embedded object and its host. These messages may be those initiated by the development and debug system and passed by the host to the object. They may also be messages generated by the host. An embedded object may be host to its own embedded objects. For these next level embedded objects, the communications function also communicates all necessary data between the this embedded object program and the embedded object subroutines hosted by this object. If there is other system communications capability, that communications is resident here, as well. Whenever executable code is downloaded from the Development and Debug System through the host PLC, the Communications function of the target, in this case the embedded object controller, will handle the download and the set up for execution.

Item 1208 handles system timing. This would include the time base for timer blocks in the embedded object application logic flow.

As with the host PLC, the heart of the embedded object operation is shown as the LogicFlow function in item 1210. The program logic for the embedded object's LogicFlow and its subroutines are identical to those of the host PLC.

FIG. 12b illustrates the logical operation of the embedded object Comm routine, which handles communications with its host, as well as with any of its embedded objects. A comparison to FIG. 10b shows that the logic is nearly identical to that of the main PLC. The logic first check, item 1220, determines whether any message from the object's host. If there is a message, it calls subroutine EObjDebug, item 1222, to process the message.

The remainder of the logic shown for the embedded object communications routine is identical to that of the main PLC's communications routine, with one slight difference in item's 1242 and 1244. Item 1224, checks to see if communications with embedded objects of this embedded object is idle. If idle, a check is made, item 1226, to see if received data from the object is available. If a message is available, it processes it, item 1228. The message could be object receive data, which would be buffered for the next time the object call block is executed. It could also be a response to a control, debug or status request message from the development and debug system, which would result in a message buffered for transmission through this object's host, to the development and debug system. A check is made, item 1230, to determine whether a message is buffered for transmission to the object. Such a buffered message could be one sent from the development and debug system and processed by the EObjDecode routine. It could also be an object data message buffered by the object call block of the this object's application program. If there is a message, the message is buffered to send in item 1234.

Whether the communications link to the object is determined not idle by block 1224, or is processed, items 1226, 1228, 1230 and 1234, a check is made to see if there are any more objects, item 1236. If this is not the last object, the process repeats for the next object. If all objects have been processed, program flow continues to item 1238. Item 1238 checks whether any messages are buffered to send to objects. If messages are available, Ocomm, item 1240, is called to start data transmission and evoke response communications from the objects. Next, item 1242 checks whether there is a message available to be sent to the host. If there is a message to be sent, HostSend, item 1244, is called to start transmission to the host.

Pertinent logic for the EObjDecode routine is shown in FIG. 12c. If the development and debug system sends a debug control message through the embedded object's host, such as a single step, breakpoint or run command, the block shown as item 1260 will detect it and pass program flow to item 1262. If item 1262 determines that the message is for this device, item 1264 will process it. Processing will generally result in commands and data being set up for action by the LogicFlow routine. If the message is for an embedded object of this device, item 1266 will detect and pass control to item 1268 to buffer a message to pass to the object. If the message is one, such as a stop all or start all, which pertains to both this device and its objects, item 1270 will transfer control to item 1272, which will both process for local action and buffer messages to embedded objects.

Data and status request messages are handled in a similar manner. When a data or status request is received, item 1274 will pass program control to item 1276. If the request is for local status or data, item 1280 will buffer a response message. If it is for data or status from a subordinate embedded object, items 1282 and 1084 will detect and buffer a message for the subordinate embedded object.

The LogicFlow and its subroutines in the embedded object are identical to those in the host PLC.

What is claimed is:

1) A development and debug system operating on a computer for creating graphical flow chart or ladder logic programs which can incorporate object subroutines and can be subsequently compiled to code that directly represents the flow chart or ladder logic and is executable within a programmable logic controller, comprising
a) a program constructor operable to enable the application developer to select, configure and connect a plurality of standard flow chart or ladder logic block elements and subroutine calls together in a manner to construct a logical program which includes object subroutines.
b) a program constructor operable to enable the creation of application developer defined objects which are programmed in graphical flow chart or ladder logic language.
c) a program constructor operable to enable the application developer to define the set of local object data variables associated with each instance of each object subroutine.
d) a program constructor operable to enable the application developer to define the set of variables and variable references passed to each object subroutine.
e) a program constructor operable to enable the creation of application developer defined program object, referred to as embedded objects, which are intended to execute on a separate subordinate processor with data transfer between the host PLC and the embedded object.
f) a program constructor operable to enable the application developer to define the set of variable data to be transferred to and from the embedded object.
g) a program constructor which allows the extended definition of embedded object of embedded object to multiple levels.
h) a program editor operable to enable the application developer to add, delete, rearrange and reconfigure flow chart or ladder logic programs or object subroutines.
i) a data structure for storing program logic in the computer's file system, which fully encapsulates both the configured details of each graphically defined program, program element and flow between the block elements.

2) A method of claim 1, wherein the program constructor comprises flow chart or ladder logic elements which allow the application developer to completely delineate object subroutines by graphical program entry without computer language program code.

3) A method of claim 1, wherein the program compiler allocates unique object data memory for each instance of each object in the application program.

4) A method of claim 1, wherein the program compiler creates object subroutine code, from graphical flow chart or ladder logic programs, which is executable by a target PLC execution engine and separate embedded object subroutine code which is executable by an embedded object execution engine.

5) A method of claim 1, wherein the program compiler creates from flow chart or ladder logic programs which include calls to embedded object subroutines, code executable by a target PLC engine which includes program calls and data transfer to object subroutines.

6) A method of claim 1 providing for debugging control, data collection and program execution inspection of the application program and all object subroutines, further comprising:
a) a method wherein the application developer can select individual program ladder logic rungs or flow chart blocks within the main program or object subroutine of a selected instance that if reached will cause execution to stop.
b) a method wherein the debugging method coordinated with the execution engine of claim 9 and embedded object execution engine of claim 10 can select and cause the execution of single step operations which will execute one flow chart block or ladder rung at a time.
c) a method wherein the debugging method coordinated with the execution engine of claim 9 and embedded object execution engine of claim 10 to collect status information and data values during program execution and while execution is stopped.
d) a method wherein the debugging method addresses debug commands intended for an embedded object to that embedded object and coordinates with execution engine of claim 9 and claim 10 to pass the message to and response back from the addressed object.

7) A method of claim 1, that provides for the development and debug system to deploy execution code to any target PLC or embedded object execution engine of a target PLC which is designed to process and execute compiled code generated by the development and debug system.

8) A method of claim 1, for programming compiled executable code, deployed according to claim 7 to the target PLC and/or embedded object execution engine for future independent operation.

9) A PLC run time execution engine that executes or supervises the execution of compiled PLC graphically programmed code including object subroutines and embedded object subroutines, comprising
a) an operating program routine which communicates with a development and debug system for program download, control commands, data transfer and debug operational control.
b) an operating program routine which communicates with embedded objects to transfer communications from and to a development and debug system, transmit embedded object input data to the embedded object and receive embedded object output data from the embedded object.
c) a method for monitoring the presence of an embedded object and the state of communications between the PLC and the embedded object.
d) a method for receiving object memory allocation definitions from the development and debug system, utilizing the allocated memory for each particular instance of each object type for object variables and keeping object data variables in the unique possession of the instance of the object.
e) a method for implementing logic execution, debug and run mode control under the supervision of the development and debug system.
f) a method for implementing unsupervised operation of program logic execution.

10) An object run time execution engine that executes or supervises the execution of compiled PLC graphically programmed embedded object code including object subroutines and embedded object subroutines, comprising
a) an operating program routine which communicates through a host PLC or embedded object, with a development and debug system for program download, control commands, data transfer and debug operational control.
b) an operating program routine which communicates with subordinate embedded objects to transfer communications from and to a development and debug system, transmit embedded object input data to the subordinate embedded object and receive embedded object output data from the subordinate embedded object.
c) a method for monitoring the presence of a subordinate embedded object and the state of communications between the embedded object and its subordinate embedded object.
d) a method for receiving object memory allocation definitions from the development and debug system, utilizing the allocated memory for each particular instance of each object type for object variables and keeping object data variables in the unique possession of the instance of the object.
e) a method for implementing logic execution, debug and run mode control under the supervision of the development and debug system.
f) a method for implementing unsupervised operation of program logic execution.

11) A method of claim 9 comprising the execution engine functional capability to automatically transfer program control from the calling program or object subroutine to a called non-embedded object subroutine and return program control to the calling program or object subroutine at the completion of the called object subroutine execution, comprising:
a) the execution engine capability for each object subroutine to transfer control to subordinate object subroutines, thereby enabling multiple levels of object subroutine execution.
b) a method for transferring data and references from one program or object subroutine to its called object subroutine.
c) the capability for a non-embedded object subroutine, at any level to access data in a common pool of global data.

12) A method of claim 10 comprising the execution engine functional capability to automatically transfer program control from the calling program object subroutine to a called non-embedded object subroutine and return program control to the calling program or object subroutine at the completion of the called object subroutine execution, comprising:
a) the execution engine capability for each object subroutine to transfer control to subordinate object subroutines, thereby enabling multiple levels of object subroutine execution.
b) a method for transferring data and references from one program or object subroutine to its called object subroutine.
c) the capability for a non-embedded object subroutine, at any level to access data in a common pool of embedded object global data.

13) A method of claim 10, for automatic identification of connected objects to allow the implementation of “plug and play” operations within a PLC system.
